(19) United States
(12) Patent Application Publication
(10) Pub. No.: US 2022/0234224 A1
(43) Pub. Date: Jul. 28, 2022

(54) KNIFE WITH INTEGRAL SEALED POWER SOURCE

(71) Applicant: Spyderco, Inc., Golden, CO (US)

(72) Inventors: Louis Sal Glesser, Evergreen, CO (US); Eric Glesser, Evergreen, CO (US)

(21) Appl. No.: 17/718,013

(22) Filed: Apr. 11, 2022

Related U.S. Application Data
(63) Continuation-in-part of application No. 17/329,563, filed on May 25, 2021.
Application No. 17/329,563 is a continuation-in-part of application No. 16/736,613, filed on Jan. 7, 2020.
(60) Provisional application No. 62/789,517, filed on Jan. 7, 2019.

(51) Int. Cl. B26B 11/00; B26B 1/10; H02J 50/12; H02J 50/00; H02J 7/00; F21V 33/00

(52) U.S. Cl. CPC B26B 11/008; B26B 1/10; H02J 50/12; B26B 1/048; H02J 7/0048; F21V 33/0084; H02J 50/001

(57) ABSTRACT

A folding knife is provided with a power storage device that can be charged and recharged by a charge component that wirelessly receives power from a remote source. In some embodiments, the folding knife can have a device that consumes energy such as a light, a camera, a microphone, an audio speaker, a display, etc. The power storage device and the charge component can be positioned in a scale of the handle where the substantially planar shapes of the scale, the power storage device, and the charge component are oriented in a common direction. In some embodiments, the cavities, recesses, and channels in the first scale that house these components and linking wires are strategically positioned to leave a reinforcing area that provides strength and stiffness to the handle. Various features also described improve safety of the charging system and provide connectivity with external computing systems and electronic devices.

### CROSS REFERENCE TO RELATED APPLICATIONS

This application is a continuation-in-part of and claims priority to U.S. patent application Ser. No. 17/329,563, filed May 25, 2021, entitled “Knife with Integral Sealed Power Source”, which is a continuation-in-part and claims priority to U.S. patent application Ser. No. 16/736,613, filed Jan. 7, 2020, entitled “Knife with Integral Sealed Power Source”, which claims priority to U.S. Provisional Patent Application Ser. No. 62/789,517, filed Jan. 7, 2019, entitled “Knife with Integral Sealed Power Source”, the entire disclosures of which are hereby expressly incorporated by reference in their entireties.

### FIELD

The present disclosure relates to cutting instruments and more specifically to knives with lights, integral sealed power sources, and/or power storage devices.

### BACKGROUND

Cutting instruments have been used for centuries by craftsmen, hunters, and others requiring a sharp cutting instrument. Pocket knives are commonly carried by sportsmen, craftsmen and other users who desire a compact, portable blade which can be safely folded and transported in a pocket or attached to a belt. More recently, fixed length knives have been replaced with popular folding knives, which generally have two positions. In an open or extended position of use, the knife cutting blade is extended to expose the blade cutting edge and permit cutting and use. In a closed position, the cutting edge of the blade is stored within a cavity or channel in the handle portion of the knife, thus preventing the blade from being exposed. Folding knives typically have a first scale and a second scale that form the handle portion of a folding knife, and may include a locking mechanism to secure the blade in a desired position.

Many sportsmen and other knife users may carry additional devices that require power, for example, a light. In some instances, users may want the additional device integrated into the knife for a variety of applications such as emitting light ahead of a blade for a cutting or thrusting action. Moreover, a vibrating mechanism can cause the blade to move in a sawing motion and some users can benefit from a heated handle in cold weather. These additional accessories or devices consume electric power, and traditional batteries can be utilized, but traditional batteries present several issues. These batteries need to be periodically inserted and removed from battery compartments, which can provide a pathway for external elements such as water to degrade the electronic components and even some of the structural components of the folding knife. Batteries with a single or limited number of uses are also harmful to the environment.

Inductive charging of integrated batteries or capacitors has been used by various industries and devices. For example, Oral-B rechargeable toothbrushes by the Braun company have used inductive charging since the early 1990s. Smart phones have been charged wirelessly via inductive charging since around 2013. Electric toothbrushes and newer smart phones are also often “sealed” to prevent damage from exposure to water. An inductively charged toothbrush can rest on the charger without any metal contacts to connect the toothbrush to the base. This has the advantage of allowing the toothbrush to be completely sealed so that water cannot enter through exposed contacts. It also avoids any problems with water getting into the contacts and shorting out the charger and creating rust on exposed metal contacts. In this inductive charging arrangement, the toothbrush and the base form a two-part transformer with the base having one part of the transformer and the toothbrush having the other. The base contains one of the coils and the metal bar, and the toothbrush contains the second coil. When the toothbrush slides onto the base, the complete transformer is created and the electric charge can flow to the battery in the toothbrush.

U.S. Pat. No. 6,553,672 to Glesser et al. discloses a folding knife with a compression locking mechanism, and is incorporated by reference herein in its entirety. U.S. Pat. No. 6,918,184 to Glesser discloses a folding knife lock with an integral stop pin, and is incorporated by reference herein in its entirety. U.S. Pat. Nos. 6,751,868 and 8,745,878 to Glesser disclose a folding knife with a substantially spherical locking mechanism, and are incorporated by reference herein in their entireties. U.S. Pat. No. 5,615,484 to Pittman discloses a cam lock for a folding knife blade, and is incorporated by reference herein in its entirety. U.S. Pat. No. 4,985,998 to Howard discloses a folding knife with a blade lock, and is incorporated by reference herein in its entirety. U.S. Pat. No. 7,305,769 to McHenry and U.S. Pat. No. 8,671,578 to Frazer disclose knives with automatic or spring-assisted opening mechanisms, and are incorporated by reference herein in their entireties. Moreover, U.S. Pat. No. 9,687,987 to Bloch discloses a knife with a replaceable blade, and is incorporated by reference herein in its entirety.

The following patents disclose various aspects of inductive charging and/or energy harvesting and are incorporated herein by reference in their entireties: U.S. Patent Publication No. 2007/0035917 Hotelling et al. for “Methods and Apparatuses for Docketing a Portable Electronic Device that has a Planar Like Configuration and that Operates in Multiple Orientations”; U.S. Patent Publication No. 2009/264044 to Paculdo for “Power of Play Toy”; U.S. Patent Publication No. 2009/256361 to Theuss for “Energy Harvester”; U.S. Patent Publication No. 2018/0212466 to Schaefer et al. for “Personal Care Product Docking System with Flux Guiding Members”; U.S. Patent Publication No. 2019/0006882 to Leem for “Transmission Coil Module for Wireless Power Transmission”; U.S. Pat. No. 3,394,277 to Satkunas et al. for “Driving Unit for Electric Toothbrush”; U.S. Pat. No. 4,031,449 to Trombly for “Electromagnetically Coupled Battery Charger”; U.S. Pat. No. 4,397,055 to Cuchiara for “Reversable Shaft with Rotary and Selective Oscillating Motion”; U.S. Pat. No. 4,644,937 to Hommann for “Mouth and Tooth Spray Apparatus”; U.S. Pat. No. 5,321,865 to Kaeser for “Oral Hygiene Device”; U.S. Pat. No. 5,613,259 to Craft et al. for “High Frequency Electric Toothbrush”; U.S. Pat. No. 6,972,543 to Wells for “Series Resonant Inductive Charging Circuit”; U.S. Pat. No. 8,975,764 to Abehasera for “Electronic Cigarette with Integrated Charging Mechanism”; U.S. Pat. No. 10,116,167 to Pomp-Melchers for “Inductive Power Transmission Device”; U.S. Pat. No. 10,116,172 to Fischer et al. for “Charging Device and Hand-Held Device for a Small Mobile Electrical Device”; U.S. Pat. No. 10,154,460 to Miller et al. for “Power Management for Wearable Devices”; U.S. Pat. No. 10,170,918 to Zadesky et al. for “Electronic Device Wireless Charging System”; and China Patent Publication No. CN102848405 to Lidong et al. for “Electric Electrician Knife”.

The following patents disclose various aspects of light installations in knives and are incorporated herein by reference in their entireties: U.S. Patent Publication No. 2004/0187313 to Zirk et al. for “Folding Knife Light Tool”; U.S. Patent Publication No. 2006/0087845 to Yeh for “Knife Structure”; U.S. Patent Publication No. 2007/0186351 to Linn et al. for “Multi Function Tool”; U.S. Patent Publication No. 2010/0085739 to Webb et al. for “Flashlight with Folding Knife”; U.S. Pat. No. 5,313,376 to McIntosh for “Multipurpose Knife/Light”; U.S. Pat. No. 5,442,529 to Hoover for Combination Knife, Light and Key Chain Device”; U.S. Pat. No. 5,626,414 to Chen for “Folding Knife with Laser Indicator”; U.S. Pat. No. 5,727,319 to Myerchin et al. for “Knife with Illuminated Blade”; U.S. Pat. No. 7,726,031 to Gibbs for “Knife System”; Spain Patent No. ES1058526U to Martinez Ortega et al. for “Cuchillo Perfeccionado con Indicador Luminoso”; China Patent Publication No. CN201120619 to Zhu for “Tool Knife with LED Lamp”; and China Patent No. CN2127901 to Zhu for “Electronic Lighting Small Knife”.

### SUMMARY

It is an aspect of embodiments of the present disclosure to provide a folding knife with an integrated power storage device and a charge component that is configured to wirelessly receive power to charge and recharge the integrated power storage device. The power may be received wirelessly from a remote source, a source to the folding knife, a source in contact the folding knife, or from other non-wired sources. The power storage device can then power various devices and components of the folding knife such as a light positioned at a forward end of the handle. Various aspects and embodiments of the present disclosure overcome unique issues with the wireless transmission of power to a folding knife and are described in further detail below.

One aspect of embodiments of the present disclosure is to provide a folding knife with a sealed power storage device and a sealed charge component arranged in a common plane. A folding knife has a planar shape, and the components of the knife, such as the scales and the blade, also have planar shapes and move relative to each other. Therefore, the minimal thickness dimensions of these components constrain the physical space for housing a power storage device and a charge component. In some embodiments, the power storage device and the charge component also have substantially planar shapes and are positioned in one or more cavities of the scales. The planar shapes of the power storage device and the charge component are aligned with the planar shape of the scale to accommodate these components in the scale. Further, these components are sealed to prevent damage to the electrical components within the knife. For example, the user may drop the knife in the sink, river, an animal, etc. and would not have to worry about the effects of the water or other moisture on the power storage device, charge component, light, or other electrical or metal components.

Another aspect of embodiments of the present disclosure is to provide a folding knife with a sealed power storage device that may be charged using wireless charging, for example, inductive charging, electromagnetic resonance, or short-wavelength wireless power transfer. Wireless power transmission transfers electrical energy from a transmitter to a receiver using the principle of induction of a magnetic field. An electric motor or a transformer using the principle of electromagnetic induction has been used since the 1800's, and since that time methods of transferring electricity by emitting electromagnetic waves such as laser or radio waves have been attempted. Wireless energy transfer methods that have been achieved thus far may be broadly divided into a magnetic induction method, an electromagnetic resonance method, and a radio frequency (RF) transmission method using a short-wavelength radio frequency. Such wireless power transfer technology has been used in industries such as information technology, rail, and consumer electronics.

It is an aspect of embodiments of the present disclosure to provide a folding knife with a charge component that wirelessly receives power via magnetic induction. This technology utilizes a phenomenon whereby, when two coils are arranged close to each other and current is applied to one coil, a magnetic flux is generated to generate electromotive force in the other coil. The magnetic induction method may transmit power of a maximum of several hundred kilowatts (kW) and may have high efficiency.

It is another aspect of embodiments of the present disclosure to provide a folding knife with a charge component that wirelessly receives power via an electromagnetic resonance method. This technology utilizes an electric field or a magnetic field, rather than using electromagnetic waves, current, or the like. The electromagnetic resonance method is hardly influenced by an electromagnetic wave, and therefore is harmless to other electronic appliances or humans.

It is a further aspect of embodiments of the present disclosure to provide a folding knife with a charge component that wirelessly receives power via a short-wavelength wireless power transfer method, which is referred to in brief as an RF transmission method. This technology utilizes a method of directly transmitting and receiving energy in the form of radio waves. This technology employs a rectenna, which is a portmanteau of “antenna” and “rectifier”, and means an element that directly converts RF power into direct current (DC) power. Therefore, the RF transmission method is a technology of converting alternating current (AC) radio waves into DC radio waves and using DC radio waves.

It is another aspect of embodiments of the present disclosure to provide a charge base that wirelessly transmits power to the charge component of the folding knife. The folding knife may have an aperture or recess to receive a protrusion located on a charge base such that the folding knife securely remains on and positioned in the correct position on the charge base. In alternative or additional embodiments, the knife handle can have a protrusion and the charge base can have an aperture or recess to receive the protrusion and properly align the knife on the charge base. Within the knife handle and circumscribing the aperture is a complimentary primary coil such that the secondary coil of the charge base lies within the electrical induction field of the primary coil. In this manner, the secondary coil is so energized to produce a current for recharging the power storage device in the knife handle. Electrical circuitry within the handle or the charge base prevents over-charging of the power storage device.

In some embodiments of the present disclosure, connected in circuit with the power storage device is an induction coil, and the induction coil is mounted upon a spool of ferrous metal or a ferrous backer board. In the example embodiment where the induction coil is mounted upon the spool, clamped on the rearward end of the power storage device is a cup-shaped bottom cap. This cap is secured to and firmly held in a cupped flange of a bracket holder. The bracket holder has a cylindrical portion extending from the cupped portion to within the spool and around the central recessed portion of the base cover. Thus, the induction coil is firmly held on the spool which in turn is snugly engaged on the bracket which in turn snugly fits over the central recessed portion. The induction coil is therefore firmly held to and in axial alignment with the power storage device.

Snugly interposed between and in engagement with the end of the spool and the cupped flange is a flat portion of an induction ring of ferrous material. This induction ring has the flat portion thereof disposed normal to the axis of the ring and the outer cylindrical portion of the ring disposed parallel to the axis of the ring. The outer cylindrical portion of the ring is in close proximity to the wall of the scale and extends radially outward as far as possible and yet within the confines of the scale. The cylindrical portion of the ring is spaced substantially radially outward from the power storage device and cap mounted on the bottom thereof. This induction ring of ferrous material is thus in a good and efficient position for receiving charging flux provided by a charge base having a coil within which the lower end of the casing, holding the induction coil, is positioned for the purpose of charging the power storage device by the process of induction charging.

Further, some folding knives utilize magnets to selectively couple the handle of the folding knife to a charge base. In such configurations, a first docking magnet can be coupled to the knife handle and a second docking magnet can be coupled to the charge base. When the folding knife is brought into contact with the charge base, the magnetic fields of the docking magnets can hold the folding knife in place. As described above, however, the internal space available for positioning the docking magnet may undesirably limit the placement location of the docking magnets. Further, for knives that also utilize inductive charging systems, the magnetic fields generated by the docking magnets may decrease the efficacy of the inductive charging system. In order to mitigate undesirable interference from the magnetic fields of the docking magnets, the distance between the docking magnets and various components of the inductive charging system may be increased. However, increasing this distance may limit options with regard to how the knife can be docked to the charge base.

The present disclosure fulfills the needs described above by, in one embodiment, providing a folding knife with a charging system comprising a charge base, a first permanent magnet positioned within the charge base, and a base charging coil positioned within the charge base. The folding knife with a charging system further comprises a handle removably mounted to the charge base and a power storage device positioned within the handle. A second permanent magnet is positioned within the handle that is configured to generate an attraction force sufficient to hold the handle to the charge base when placed in proximity to the first permanent magnet. A handle charging coil is positioned within the handle. The base charging coil is configured to generate a magnetic field that penetrates the second charging coil to charge the power storage device when placed in proximity to the handle charging coil. The folding knife with a charging system further comprises a handle flux guiding member or shield having at least a portion positioned within the handle charging coil and a stand flux guiding member having at least a portion positioned within the base charging coil.

In another embodiment, a knife with a charging system comprises a charge base, a first permanent magnet positioned within the charge base, and a charge coil positioned within the charge base. A handle of a folding knife is removably mounted to the charge base. A rechargeable power storage device is positioned within the handle of the folding knife. A second permanent magnet is also positioned within the handle and configured to generate an attraction force sufficient to hold the handle to the charge base when placed in proximity to the first permanent magnet. A handle coil is positioned within the handle. The charge coil is configured to generate a magnetic field that penetrates the handle coil to charge the rechargeable power storage device. The knife with a charging system also comprises a handle flux guiding member in close proximity to a surface of the first permanent magnet.

Besides penetrating the handle coil, the magnetic field generated during inductive charging can potentially also penetrate other components positioned within the handle. Additionally, the stray magnetic field can cause noise in conductive materials (e.g., integrated circuits, printed circuit board traces, etc.) and create electromagnetic interference issues. The stray magnetic field can also cause eddy currents in conductive objects, which can generate heat and decrease the magnetic field strength.

In order to mitigate various undesirable side effects of inductive charging, a handle flux guiding member and a base flux guiding member can be utilized. Each of the handle flux guiding member and the base flux guiding member can comprise a magnetic material that allows them to influence the magnetic field in its environment. A material such as ferrite, for instance, has a greater permeability to a magnetic field than air and therefore concentrates the magnetic field lines. By strategic placement of the handle flux guiding member and the stand flux guiding member, the magnetic field associated with the inductive charging system can be concentrated and shaped, such that the efficiency of the inductive charging system is improved and undesirable coupling effects with other components of the handle and the base are reduced. Further, the handle flux guiding member and the stand flux guiding member can screen or otherwise guide the flux from external sources that may produce magnetic fields that penetrate the handle coil.

In some embodiments of the present disclosure, a power transmission device for inductive energy transfer is provided. The power transmission device comprises a first stage adapted to be connected to a supply input voltage and adapted to convert the supply input voltage to an operating voltage. The power transmission device further includes a second stage comprising a resonant circuit connected to the first stage and adapted to generate an oscillating voltage from the operating voltage so as to generate a magnetic field for inductive transfer of energy from the power transmission device to a target device. A control circuit is connected to the second stage. The control circuit is adapted to detect a parameter value of the second stage and is adapted to start or stop amplification of the resonant circuit based on the detected parameter value.

In further embodiments of the present disclosure, a charging device having contactless transmission of electrical energy in order to supply energy to a folding knife is provided. An electronic circuit for feeding an inductive energy transmitter is designed to adapt energy fed to the inductive energy transmitter in accordance with energy drawn from the inductive energy transmitter. A power storage device of the folding knife interrupts the supply of a load when energy is fed into the power storage device by the inductive energy transmitter.

With regards to non-contact platforms, inductive coils can be placed in each device to transfer both power and data. The inductive coils are typically hidden from view behind the housings of each device and therefore they are more aesthetically pleasing than electrical contacts, which need to be exposed in order to operate effectively. Furthermore, inductively based systems are more robust than electrical contacts. For example, there are no contacts to wear out and/or oxidize.

In some cases, the interfacing systems need to be properly aligned in order to ensure proper connections and therefore efficient power and data transfer between the charge base and the folding knife. The alignment features may be fixed or adjustable, and may include such elements as pins, shelves, guides, reference surfaces, keyways, magnets, snap features, or the like. The alignment features may also provide visual alignment clues or fiduciaries for helping the user position the knife on the docking station.

One aspect of embodiments of the present disclosure is to provide a folding knife with an energy harvesting mechanism to collect energy generated by the user using or carrying the knife. The energy harvesting mechanism can be positioned in a scale of the folding knife handle and can be, for instance, a magnet positioned in an electromagnetic generator. Movement of the magnet induces a change in flux in the generator, which can be stored as electrical energy. In addition, other movements such as the blade relative to the handle can power one or more energy harvesting mechanisms in the folding knife.

Some exemplary advantages of aspects and embodiments described herein include, but are not limited to, (i) protected connections-no corrosion when the electronics are enclosed and away from water or oxygen in the atmosphere and less risk of electrical faults such as short circuits due to insulation failure, especially where connections are made or broken frequently; (ii) durability-without the need to constantly plug and unplug the device, there is significantly less wear and tear on the socket of the device and the attaching cable or hatches to open to change batteries; (iii) increased convenience and aesthetic quality-no need for cables or replacement batteries; and (iv) inductive charging systems can be operated automatically without dependence on people to plug and unplug, which results in higher reliability. With one or more power storage devices charged, the folding knife can power a number of components including, but not limited to, a light, a locking mechanism, an opening mechanism, a microphone, an audio speaker, a GPS beacon or device, an altimeter, a compass, environment sensors (e.g., barometers, thermometers, hygrometers, or air quality sensors including oxygen level, carbon dioxide level, carbon monoxide level, smoke, or the like), a fitness tracker, a heart monitor, a blood sugar monitor, a transmitter, a receiver, a transceiver, a pH sensor, a position sensor, a hand warmer, a vibrating mechanism, a camera or video recorder, a communication device, a clock, a radio, an audio/music player, a speaker, or a data storage device with an interface such as USB, memory card, or other flash drive medium, etc.

A specific embodiment of the present disclosure is a folding knife that wirelessly receives power from a remote source, comprising a handle having a first scale and a second scale that define a channel positioned therebetween, wherein the first scale has a substantially planar shape and includes a charge cavity; a blade pivotally interconnected to a forward end of the handle, wherein the blade has a cutting edge, the blade is movable between a first closed position where the cutting edge is positioned in the channel and a second extended position where the cutting edge is positioned outside of the channel; and a charge component positioned in the charge cavity for wirelessly receiving power and transferring power to a power storage device at least partially positioned in the handle and/or along or in a spine of the knife, wherein the charge component and the power storage device each have a substantially planar shape, and wherein the substantially planar shapes of the power storage device, the charge component, and the first scale are oriented in a common direction.

In some embodiments, the charge component is one of an inductive coil, a resonator coil, and/or an RF antenna. In various embodiments, the power storage device is one of a battery and/or a capacitor. In some embodiments, the planar shape of the power storage device has a ratio between a maximum dimension in a planar direction to a maximum dimension in a thickness direction that is greater than eight. In various embodiments, the folding knife further comprises a device electrically connected to a control unit, wherein at least one of the first scale, the second scale, a liner, a liner lock, a back lock, a pivot tie, or a split spring provides the electrical connection between the device and the control unit. In some embodiments, the power storage device is positioned in a storage cavity in the first scale, and a storage channel extends between the storage cavity and the charge cavity.

Another specific embodiment of the present disclosure is a folding knife that wirelessly receives power from a remote source, comprising a handle having a first scale and a second scale that define a channel positioned therebetween; a blade pivotally interconnected to a forward end of the handle, wherein the blade has a cutting edge, and the blade is movable between a first closed position where the cutting edge is positioned in the channel and a second extended position where the blade cutting edge is positioned outside of the channel; a charge cavity extending into an inner surface of the first scale; a charge component positioned in the charge cavity for wirelessly receiving power and transferring power to a power storage device at least partially positioned in the handle and/or along or in a spine of the knife; and a plurality of channels extending into the inner surface of the first scale, wherein a device channel in the plurality of channels extends from a device recess or aperture to the charge cavity, and an activation channel in the plurality of channels extends from an activation recess or aperture to the charge cavity, and wherein a reinforcement area is defined between the device channel and the activation channel to increase a strength and stiffness of the first scale.

In some embodiments, the folding knife further comprises a plurality of cutout areas extending into an inner surface of the second scale, wherein a combined area of the plurality of cutout areas is larger than a combined area of the charge cavity and the plurality of channels. In various embodiments, the folding knife further comprises a control unit positioned in the charge cavity, wherein the charge component and the power storage device are electrically connected to the control unit; and a light positioned in the device recess or aperture, wherein a wire extends from the light, through the device channel to the control unit, and the control unit transfers power from the power storage device to the light upon the control unit receiving a signal. In various embodiments, the folding knife further comprises a control unit positioned in the charge cavity, wherein the charge component and the power storage device are electrically connected to the control unit; and a storage channel of the plurality of channels extends from a storage cavity to the charge cavity, wherein the power storage device is positioned in the storage cavity, and wherein a wire extends from the power storage device, through the storage channel, and to the control unit to electrically connect the power storage device and the control unit.

In some embodiments, the first scale, the charge component, and the power storage device each have a substantially planar shape, and wherein the substantially planar shapes of the power storage device, the charge component, and the first scale are oriented in a common direction. In various embodiments, the charge component and the power storage device are sealed in an enclosed volume against external elements such that a fluid outside of the enclosed volume cannot move into the enclosed volume. In some embodiments, the folding knife further comprises a control unit positioned in the charge cavity, wherein the charge component and the power storage device are electrically connected to the control unit; and an activation device positioned in the activation recess or aperture, wherein a wire extends from the activation device, through the activation channel, and to the control unit, and the activation device transmits a signal to the control unit through the wire.

A further specific embodiment of the present disclosure is a wireless charging system for a folding knife, comprising a folding knife having a handle with a first scale and a second scale that define a channel; a blade pivotally interconnected to a forward end of the handle, wherein the blade has a cutting edge, and the blade is movable between a first closed position where the cutting edge is positioned in the channel and a second extended position where the cutting edge is positioned outside of the channel; a first charge component positioned in the handle and configured to transfer power to a power storage device in the handle of the folding knife, wherein the first charge component comprises windings extending in a first plane; and a base having a second charge component that is configured to wirelessly transmit power to the first charge component, wherein the second charge component comprises windings extending in a second plane, and wherein the first and second plane are oriented substantially parallel to each other and offset from each other by less than 5 cm when an outer surface of one of the first scale or the second scale of the folding knife is placed on an upper surface of the base.

In various embodiments, the charging system further comprises a protrusion extending upward from the upper surface of the base that at least partially extends into the knife recess to locate the first charge component relative to the second charge component when the outer surface of one of the first scale or the second scale of the folding knife is placed on the upper surface of the base. In some embodiments, the charging system further comprises a position sensor in the handle of the folding knife, wherein the position sensor is configured to detect the blade in the first closed position and the blade in the second extended position, wherein the position sensor sends a signal to a control unit in the handle when the blade is in the second extended position, and the control unit activates a device in response to the signal. In various embodiments, the device is one of a light, a locking mechanism, an opening mechanism, a microphone, an audio speaker, a GPS beacon or device, an altimeter, a compass, environment sensors (e.g., barometers, thermometers, hygrometers, air quality sensors including oxygen level, carbon dioxide level, carbon monoxide level, smoke, or the like), a fitness tracker, a heart monitor, a blood sugar monitor, a transmitter, a receiver, a transceiver, a pH sensor, a position sensor, a hand warmer, a vibrating mechanism, a camera or video recorder, a communication device, a clock, or a data storage device with an interface such as USB, memory card, or other flash drive medium.

In some embodiments, the charging system further comprises a position sensor in the handle of the folding knife, wherein the position sensor is configured to detect the blade in the first closed position and the blade in the second extended position, wherein the position sensor sends a signal to a control unit in the handle when the blade is in the first closed position, and the control unit prevents the power storage device from charging in response to the signal. In various embodiments, the position sensor is one of an inductive sensor, a mechanical contact switch, a momentary contact switch, or a photoelectric switch. In some embodiments, the charging system further comprises an electromagnetic shield positioned between the first charge component and the position sensor in the handle.

In other embodiments, the control unit allows the power storage device to charge when the blade is in the first closed position and/or in the second extended position. It is noted the control unit may allow the power storage device to charge if a signal is received from the position sensor when the blade is detected in the first closed position and/or the second extended position, or if no signal is received from the position sensor.

Another specific embodiment of the present disclosure is a knife that wirelessly receives power from a remote source, comprising a handle having a first scale and a second scale; a blade interconnected to a forward end of the handle, wherein the blade has a cutting edge; a charge cavity extending into an inner surface of the first scale; a charge component positioned in the charge cavity for wirelessly receiving power and transferring power to a power storage device at least partially positioned in the handle and/or along or in a spine of the knife; and a plurality of channels extending into the inner surface of the first scale, wherein a device channel of the plurality of channels extends from a device recess or aperture to the charge cavity, and an activation channel of the plurality of channels extends from an activation recess or aperture to the charge cavity, and wherein a reinforcement area is defined between the device channel and the activation channel to increase a strength and stiffness of the first scale.

In some embodiments, the knife further comprises a plurality of cutout areas extending into an inner surface of the second scale, wherein a combined area of the plurality of cutout areas is larger than a combined area of the charge cavity and the plurality of channels. In various embodiments, the knife further comprises a control unit positioned in the charge cavity, wherein the charge component and the power storage device are electrically connected to the control unit; and a light positioned in the device recess or aperture, wherein a wire extends from the light, through the device channel to the control unit, and the control unit transfers power from the power storage device to the light upon the control unit receiving a signal. In some embodiments, the knife further comprises a control unit positioned in the charge cavity, wherein the charge component and the power storage device are electrically connected to the control unit; and a storage channel of the plurality of channels extends from a storage cavity to the charge cavity, wherein the power storage device is positioned in the storage cavity, and wherein a wire extends from the power storage device, through the storage channel, and to the control unit to electrically connect the power storage device and the control unit.

In various embodiments, the knife further comprises a control unit positioned in the charge cavity, wherein the charge component and the power storage device are electrically connected to the control unit; and an activation device positioned in the activation recess or aperture, wherein a wire extends from the activation device, through the activation channel, and to the control unit, and the activation device transmits a signal to the control unit through the wire. In some embodiments, the first scale, the charge component, and the power storage device each have a substantially planar shape, and wherein the substantially planar shapes of the power storage device, the charge component, and the first scale are oriented in a common direction, wherein the charge component and the power storage device are sealed in an enclosed volume against external elements such that a fluid outside of the enclosed volume cannot move into the enclosed volume. In various embodiments, the first scale and the second scale define a channel positioned therebetween, and the blade is pivotally interconnected to the forward end of the handle, and wherein the blade is movable between a first closed position where the cutting edge is positioned in the channel and a second extended position where the cutting edge is positioned outside of the channel.

Another particular embodiment of the present disclosure is a handheld tool that wirelessly receives power from a remote source, comprising: a handle defining a first cavity and a second cavity; a first electrical system at least partially positioned in the first cavity, wherein the first electrical system comprises a first charge component for wirelessly receiving power and transferring power to a first power storage device, a first activation device operably connected to the first power storage device, and a first light operably connected to the first power storage device; a second electrical system at least partially positioned in the second cavity, wherein the second electrical system comprises a second charge component for wirelessly receiving power and transferring power to a second power storage device, a second activation device operably connected to the second power storage device, and a second light operably connected to the second power storage device; and wherein the first and second electrical systems are independent such that engaging the first activation device cycles only the first light through at least one mode of operation, and engaging the second activation device cycles only the second light through at least one mode of operation.

In some embodiments, the handheld tool further comprises a first control unit of the first electrical system and a second control unit of the second electrical system; and an orientation sensor operably connected to the first and second control units, wherein when the orientation sensor detects the first charge component positioned below the second charge component, then the first control unit allows the first charge component to transfer power to the first power storage device, and the second control unit prevents the second charge component from transferring power to the second power storage device. In various embodiments, the first light emits light having a first color, and the second light emits light having a second color. In some embodiments, the first color is white, and the second color is red.

In various embodiments, the handheld tool further comprises a first control unit of the first electrical system and a second control unit of the second electrical system; an aperture extending through the handle; and an indicator light positioned in the handle and configured to emit a light into the aperture that is visible from both sides of the handle, wherein the indicator light is operably connected to at least one of the first and second control units. In some embodiments, the charge component of the first electrical system comprises windings extending in a first plane, the charge component of the second electrical system comprises windings extending in a second plane, and the first and second planes are substantially parallel. In various embodiments, the at least one mode of operation includes activating the first light and activating the second light.

A further particular embodiment of the present disclosure is a handheld tool that wirelessly receives power from a remote source, comprising: a handle defining a first cavity and a second cavity; a first electrical system at least partially positioned in the first cavity, wherein the first electrical system comprises a first charge component for wirelessly receiving power, a first power storage device operably connected to the first charge component, a first activation device operably connected to the first power storage device and partially extending outside the handle, and a first light operably connected to the first power storage device; a second electrical system at least partially positioned in the second cavity, wherein the second electrical system comprises a second charge component for wirelessly receiving power, a second power storage device operably connected to the second charge component, a second activation device operably connected to the second power storage device and partially extending outside the handle, and a second light operably connected to the second power storage device; and wherein the first and second electrical systems are interconnected such that the first charge component is configured to transfer power to both of the first and second power storage devices, and the second charge component is configured to transfer power to both of the first and second power storage devices.

In various embodiments, engaging the first activation device cycles the first and second lights through at least one mode of operation, and engaging the second activation device cycles the first and second lights through at least one mode of operation. In some embodiments, the handheld tool further comprises a first control unit of the first electrical system and a second control unit of the second electrical system; and an orientation sensor operably connected to the first and second control units, wherein when the orientation sensor detects the first charge component positioned below the second charge component, then the first control unit allows the first charge component to transfer power to the first power storage device, and the second control unit prevents the second charge component from transferring power to the second power storage device. In various embodiments, the light of the first electrical system and the light of the second electrical system each emit light having the same color.

In some embodiments, the at least one mode of operation includes activating the first light, activating the second light, and activating both of the first and second lights. In various embodiments, the first and second charge components are each one of an inductive coil, a resonator coil, and an RF antenna. In some embodiments, the handheld tool further comprises a first scale and a second scale of the handle that define a channel positioned therebetween, and the first scale defines the first cavity and the second scale defines the second cavity; a blade pivotally interconnected to a forward end of the handle, wherein the blade has a cutting edge, the blade is movable between a first closed position where the cutting edge is positioned in the channel and a second extended position where the cutting edge is positioned outside of the channel; and wherein the first and second charge components and the first and second power storage devices each have a substantially planar shape, and wherein the substantially planar shapes of the first power storage device, the first charge component, and the first scale are oriented in a first plane, and wherein the substantially planar shapes of the second power storage device, the second charge component, and the second scale are oriented in a second plane.

In another particular embodiment or embodiments, a handheld tool that wirelessly receives power from a remote source, comprising a handle defining a first cavity positioned closer to a first side surface of the handle than an opposing second side surface of the handle; a first electrical system at least partially positioned in the first cavity, wherein the first electrical system comprises a first control unit, a first charge component operably connected to the first control unit and configured to wirelessly receive power, and a first power storage device operably connected to the first control unit and configured to receive power from the first charge component; and an orientation sensor operably connected to the first control unit, wherein when the orientation sensor detects the first side surface positioned below the second side surface, then the first control unit allows the first charge component to transfer power to the first power storage device.

In some embodiments, the handheld tool further comprises a second electrical system at least partially positioned in a second cavity of the handle, wherein the second electrical system comprises a second control unit, a second charge component operably connected to the second control unit and configured to wirelessly receive power, and a second power storage device operably connected to the second control unit and configured to receive power from the second charge component, wherein when the orientation sensor detects the first side surface positioned below the second side surface, then the second control unit prevents the second charge component from transferring power to the second power storage device. In various embodiments, when the orientation sensor detects the first side surface positioned below the second side surface, the first control unit allows the first charge component to transfer power to both of the first and second power storage devices.

In some embodiments, the first electrical system has a first activation device that is operably connected to the first power storage device, and the first electrical system has a first light operably connected to the first power storage device; wherein the second electrical system has a second activation device that is operably connected to the second power storage device, and the second electrical system has a second light operably connected to the second power storage device; and wherein the first and second electrical systems are independent such that engaging the first activation device cycles only the first light through at least one mode of operation, and engaging the second activation device cycles only the second light through at least one mode of operation. In various embodiments, the first electrical system has a first activation device that is operably connected to the first power storage device, and the first electrical system has a first light operably connected to the first power storage device; wherein the second electrical system has a second activation device that is operably connected to the second power storage device, and the second electrical system has a second light operably connected to the second power storage device; and wherein the first and second electrical systems are interconnected such that the first charge component is configured to transfer power to both of the first and second power storage devices, and the second charge component is configured to transfer power to both of the first and second power storage devices. In some embodiments, the remote source is one of a planar charge base or a wired connection.

Another particular embodiment of the present disclosure is a handheld tool that wirelessly receives power from a remote source, comprising a handle having an interior surface with a cavity extending into said interior surface; an electrical system at least partially positioned in said cavity, wherein said electrical system comprises a control unit, a charge component operably connected to said control unit and configured to wirelessly receive power, and a power storage device operably connected to said control unit and configured to receive power from said charge component; and a power consumption device that is operably connected to said electrical system, wherein said power consumption device is configured to receive power from said power storage device.

In some embodiments, said handle is part of one of a folding knife or a fixed-blade knife. In various embodiments, said power consumption device is one of a light, a USB drive, or a clock. In some embodiments, said electrical system is hermetically sealed within said cavity of said handle. In various embodiments, the handheld tool further comprises an orientation sensor operably connected to said control unit, wherein said cavity is positioned closer to a first side surface of said handle than an opposing second side surface of said handle, wherein when said orientation sensor detects said first side surface positioned below said second side surface, then said control unit allows said charge component to transfer power to said power storage device. In various embodiments, the handheld tool further comprises a second electrical system at least partially positioned in a second cavity of said handle, wherein said second electrical system comprises a second control unit, a second charge component operably connected to said second control unit and configured to wirelessly receive power, and a second power storage device operably connected to said second control unit and configured to receive power from said second charge component, wherein when said orientation sensor detects said first side surface positioned below said second side surface, then said second control unit prevents said second charge component from transferring power to said second power storage device.

Another particular embodiment of the present disclosure is a handheld tool that wirelessly receives power. The handheld tool includes a handle defining a first cavity. The handheld tool includes an electrical system at least partially positioned in the first cavity. The electrical system includes a charge component for receiving power and transferring power to a power storage device, and an activation device operably connected to the power storage device. The handheld tool includes a control unit of the electrical system. The control unit is at least partially positioned in the first cavity. The handheld tool includes one or more sensors. Each of the one or more sensors are at least partially positioned within the first cavity or at least a second cavity defined within the handle. Each of the one or more sensors are configured to collect sensor data and provide the sensor data to the control unit.

In some embodiments, the one or more sensors are configured to collect operation data about one or more components of the handheld tool and provide the operation data to the control unit, wherein the operation data includes at least one of amount of remaining charge of the power storage device, time in use since charge of the power storage device, total time since charge of the power storage device, condition or health of the power storage device, light activation or deactivation, handheld tool lock activation or deactivation, handheld tool cycle count, aural inputs or outputs, visual inputs or outputs, or haptic inputs or outputs.

In some embodiments, the one or more sensors are configured to collect environment data about a surrounding environment in which the handheld tool is operated and provide the environment data to the control unit. The environment data includes at least one of a GPS signal, a compass heading, an altimeter reading, a barometer reading, a thermometer reading, a hygrometer (humidity) reading, or a pH reading.

In some embodiments, the one or more sensors are configured to collect user data about a user operating the handheld tool and provide the user data to the control unit. The user data includes at least one of a fitness measurement, a position measurement of the handheld tool relative to a portion of the user, an accelerometer or G meter reading, a heart rate or pulse rate, blood sugar level, or a pulse oximetry reading.

In some embodiments, the handheld tool includes a data storage device. In some embodiments, the handheld tool includes a microphone positioned within the handle and configured to receive verbal communication from a user, and the control unit is configured to store the verbal communication in the data storage device. In some embodiments, the handheld tool includes a camera positioned within the handle and configured to capture at least one of an image or a video, and the control unit is configured to store the at least one of an image or a video in the data storage device. In some embodiments, the data storage device is at least one of memory integrated in said control unit or a flash medium including a USB drive or a memory card insertable in said handle. For example, the data storage device may be inserted during manufacturing of the handheld tool, or may be provided as an insertable accessory either with the purchase of the handheld tool or as a separately-purchasable accessory. In other embodiments, the data storage device may be managed and/or interfaced through Bluetooth or other wireless data protocol known in the art.

In some embodiments, the electrical system includes a light operably connected to the power storage device. In some embodiments, the handheld tool includes a user interface in communication with said control unit. The user interface is at least partially positioned within the handle. The user interface includes a display. For example, the display may be backlit or non-backlit. The user interface may include a user input device. The user input device may be the activation device or in addition to the activation device.

In some embodiments, the handheld tool includes one or more components at least partially positioned within the first cavity or the second cavity defined within the handle. The one or more components include at least one of an emergency locator or beacon, a compass, an altimeter, a barometer, a thermometer, a pH sensor, a fitness tracker, a position sensor, an accelerometer or G meter, a heart monitor, a blood sugar monitor, a pulse oximeter, a location tag, a watch or internal clock, a laser pointer or targeting tool, a laser sight or distance measurement device, a mechanical sound emitter, or a hand warmer. At least some of the one or more components are operably connected to the control unit.

In some embodiments, the handheld tool is a folding blade knife, a fixed blade knife, a multi-tool, a box cutter, scissors, a saw, a drill, a hammer, a screwdriver, a ratchet, pliers, a wrench, snips, a level, a tape measurer, a shovel, a gardening or tree trimming tool, or a battery-operated power tool.

A further embodiment of the present disclosure is a handheld tool that wirelessly receives power. The handheld tool includes a handle defining a first cavity. The handheld tool includes an electrical system at least partially positioned in the first cavity. The electrical system includes a charge component for receiving power and transferring power to a power storage device, and an activation device operably connected to the power storage device. The handheld tool includes a control unit of the electrical system. The control unit is at least partially positioned in the first cavity. The handheld tool includes a device for at least one of data transmission or reception. The device may include a transmitter (TX) unit, a receiver (RX) unit, and/or a transmitter and receiver (TX/RX) unit operably connected to the control unit and at least partially positioned within the first cavity or a second cavity defined within the handle. The TX unit, RX unit, and/or TX/RX unit are configured to transmit output data from the control unit, receive input data, and/or provide the input data to the control unit.

In some embodiments, the TX unit, RX unit, and/or TX/RX unit are configured to communicate with at least one of a computer system, personal electronic device, or intermediate server configured to execute one or more program instructions for a program or application including a user portal or dashboard configured for a user to view the transmitted output data, and further configured for services related to ownership, registration, and support of the handheld tool. In some embodiments, the TX unit, RX unit, and/or TX/RX unit are configured for Bluetooth, and the control unit is configured to transmit the output data and receive the input data via Bluetooth. In general, the TX unit, RX unit, and/or TX/RX unit may be configured for any known data transmitting and receiving protocol known in the art. In one non-limiting example, the protocol may be any wireless protocol usable with handheld devices.

A further particular embodiment of the present disclosure is a knife that wirelessly receives power. The knife includes a handle defining a first cavity. The knife includes a blade at least partially positioned in the handle. The knife includes an electrical system at least partially positioned in the first cavity. The electrical system includes a charge component for receiving power and transferring power to a power storage device, and an activation device operably connected to the power storage device. The knife includes a control unit of the electrical system. The control unit is at least partially positioned in the first cavity. The knife includes one or more sensors. Each of the one or more sensors is at least partially positioned within the first cavity or at least a second cavity defined within the handle. Each of the one or more sensors is configured to collect sensor data and provide the sensor data to the control unit.

In some embodiments, the blade is rotatably connected to the handle and the knife is a folding knife. In some embodiments, the knife includes a first scale and a second scale of the handle that define a channel positioned therebetween, and the first scale defines the first cavity and the second scale defines the second cavity. The blade is pivotally interconnected to a forward end of the handle. The blade has a cutting edge. The blade is being movable between a first closed position where the cutting edge is positioned in the channel and a second extended position where the cutting edge is positioned outside of the channel. The charge component and the power storage device each have a substantially planar shape. The substantially planar shape of the power storage device, the charge component, and the scales are oriented in a plane. In some embodiments, the blade is fixedly connected to the handle and the knife is a fixed blade knife.

In some embodiments, the blade includes a device for at least one of data transmission or reception. The device may include a transmitter (TX) unit, a receiver (RX) unit, and/or a transmitter and receiver (TX/RX) unit operably connected to the control unit and at least partially positioned within the first cavity or the second cavity defined within the handle. The TX unit, RX unit, and/or TX/RX unit are configured to transmit output data from the control unit, receive input data, and/or provide the input data to the control unit. The output data includes the sensor data. In some embodiments, the TX unit, RX unit, and/or TX/RX unit are configured to communicate with at least one of a computer system, personal electronic device, or intermediate server configured to run a program or application including a user portal or a dashboard for a user to view the transmitted output data, and further configured for services related to ownership, registration, and support of the knife. In some embodiments, the TX unit, RX unit, and/or TX/RX unit are configured for Bluetooth, and the control unit is configured to transmit the output data and receive the input data via Bluetooth.

In some embodiments, the knife—via the TX unit, RX unit, and/or TX/RX unit—can control one or more apps on a user's smart phone or other personal electronic device and/or can control other devices such as, but not limited to, ear buds, a wireless speaker, or a microphone. In additional embodiments, the user's smart phone or other personal electronic device can control the knife—via the TX unit, RX unit, and/or TX/RX unit—and/or control other devices connected to the knife such as, but not limited to, ear buds, a wireless speaker, or a microphone. In additional embodiments, devices connected to the knife such as ear buds, a wireless speaker, or a microphone can transmit and/or receive data (e.g., in the form of electrical signals converted to outputted sound waves or from recorded sound waves)—via the TX unit, RX unit, and/or TX/RX unit—to one or more apps on a user's smart phone or other personal electronic device. Thus, the knife is in communication with the user's smart phone or other personal electronic device and the additional device such as, but not limited to, ear buds, a wireless speaker, or a microphone. The user's smart phone or other personal electronic device is also in communication with the knife and the additional device such as, but not limited to, ear buds, a wireless speaker, or a microphone. Further, the additional device such as, but not limited to, ear buds, a wireless speaker, or a microphone is also in communication with the user's smart phone or other personal electronic device and the knife.

In additional embodiments, a control unit includes one or more processors and memory. The memory is configured to store a set of program instructions. The one or more processors are configured to execute program instructions causing the one or more processors to perform one or more steps of methods or processes related to a program or application (app). The control unit is couplable to a user interface. The user interface can include one or more of a display, user input devices such as an activation device or a microphone, aural output devices such as a speaker, haptic output devices such as a vibration motor, or visual input devices such as a camera.

In another particular embodiment, a handheld tool that wirelessly receives power includes a handle defining a first cavity. The handheld tool includes an electrical system at least partially positioned in the first cavity and which includes a charge component for receiving power and transferring power to a power storage device, and an activation device operably connected to the power storage device. The handheld tool includes a control unit of the electrical system, which is at least partially positioned in the first cavity. The handheld tool includes a light pipe positioned proximate to an aperture in the handle, where the light pipe is configured to illuminate with at least one color from at least one indicator light, where the at least one color corresponds to an operational status of the charge component. In some embodiments, the light pipe can be white light to illuminate an area for the user.

In some embodiments, the aperture is a lanyard aperture within the handle, and the light pipe forms a ring about an inner surface of the lanyard aperture. In some embodiments, the light of at least one color includes a first color corresponding to a first operational status where a stored power level within the power storage device is below a first power level threshold, a second color corresponding to a second operational status where the stored power level within the power storage device is above a second power level threshold, and a third color corresponding to a third operational status where the power storage device is receiving power. In some embodiments, the third color corresponds to a third stored power level between the first power level threshold and the second power level threshold. In some embodiments, the first color is red, the second color is green, and the third color is yellow. In some embodiments, the at least one color blinks intermittently at pre-determined time intervals.

In some embodiments, the handheld tool includes a lens positioned over the aperture. The at least one light is visible through the lens. In some embodiments, the lens is fabricated from a plastic, a protective glass, sapphire, or a glass with one or more focusing, magnifying, reflective, or refractive properties.

In another embodiment, a knife that wirelessly receives power includes a handle with a first scale and a second scale that define a channel positioned therebetween, where the first scale and the second scale at least partially surround a handle spine, and where the first scale at least partially defines a first cavity and the second scale at least partially defines a second cavity. The knife includes an electrical system at least partially positioned in said first cavity and said second cavity. The electrical system includes at least one battery. The electrical system includes electronics housed on boards with communication traces running between the scales to said battery, where a discharge of the at least one battery is regulated by the electronics. The electrical system includes at least one indicator light configured to indicate at least one operational status of the knife, where the at least one indicator light is configured to pass through a light pipe at a first end, where a second end of the light pipe is positioned at an aperture in the handle, and where at least one operational status includes a charge level of said battery monitored by the electronics. Alternatively or in addition, the light pipe can provide light to an environment such that a specific area is illuminated for the user. The electrical system includes at least one bulb configured to illuminate a portion of an external environment surrounding said knife. The electrical system includes at least one switch positioned in a plane along the spine and above the battery. The electrical system includes a Bluetooth antenna. The knife includes a blade at least partially positioned in the handle. The blade is pivotally interconnected to a forward end of said handle. The blade has a cutting edge. The blade is movable between a first closed position where the cutting edge is positioned in the channel and a second extended position where the cutting edge is positioned outside of said channel. The arrangement of the electrical system and the blade provides a radiation path with a reduced level of obstruction for at least one of receiving and transmitting data via the Bluetooth antenna. It is noted the knife may include components or methods to balance, distribute, remove, or direct heat within the knife.

In some embodiments, the at least one indicator light includes three light emitting diodes configured to provide light communicating said operational status of said knife, the aperture is a lanyard aperture of the handle, the at least one bulb includes two bulbs, and the at least one switch includes two switches. In some embodiments, the blade is held in the first closed position or the second extended position via a lock. In some embodiments, the blade is positioned to prevent interference of the receiving or transmitting data via the Bluetooth antenna by reducing the blade operating as a reflector or a ground plane.

In another particular embodiment, a handheld tool that wirelessly receives power includes a handle defining a first cavity and a second cavity. The handheld tool includes an electrical system at least partially positioned in the first cavity. The electrical system includes a charge component for receiving power and transferring power to a power storage device, and an activation device operably connected to the power storage device. The handheld tool includes a control unit of the electrical system which is at least partially positioned in the first cavity. The handheld tool includes one or more sensors. Each of the one or more sensors are at least partially positioned within the first cavity or the second cavity. Each of the one or more sensors are configured to collect sensor data and provide the sensor data to the control unit.

In some embodiments, the one or more sensors are configured to collect operation data about one or more components of the handheld tool and provide the operation data to the control unit. The operation data includes at least one of amount of remaining charge of the power storage device, time in use since charge of the power storage device, total time since charge of the power storage device, condition or health of the power storage device, light activation or deactivation, tool lock activation or deactivation, tool cycle count, aural inputs or outputs, visual inputs or outputs, or haptic inputs or outputs.

In some embodiments, the one or more sensors are configured to collect environment data about a surrounding environment in which the handheld tool is operated and provide the environment data to the control unit. The environment data includes at least one of a GPS signal, a compass heading, an altimeter reading, a barometer reading, a thermometer reading, a hygrometer reading, or a pH reading.

In some embodiments, the one or more sensors are configured to collect user data about a user operating the handheld tool and provide the user data to the control unit. The user data includes at least one of a fitness measurement, a position measurement of the handheld tool relative to a portion of the user, an accelerometer or G meter reading, a heart rate or pulse rate, a blood sugar level, or a pulse oximetry reading.

In some embodiments, the handheld tool includes a data storage device at least partly positioned in the handle. In some embodiments, the handheld tool includes a microphone positioned within the handle and configured to receive verbal communication from a user. The control unit is configured to store the verbal communication in the data storage device. In some embodiments, the handheld tool includes a camera positioned within the handle and configured to capture at least one of an image or a video. The control unit is configured to store the at least one of an image or a video in the data storage device. In some embodiments, the data storage device is at least one of memory integrated in the control unit or a flash medium including a USB drive or a memory card insertable in the handle.

In some embodiments, the electrical system includes a light operably connected to the power storage device. In some embodiments, the handheld tool includes a user interface in communication with the control unit. The user interface is at least partially positioned within the handle. The user interface includes a display. In some embodiments, the user interface is in communication with a second activation device. The second activation device activates a light within the handle.

In some embodiments, the handheld tool includes one or more components at least partially positioned within the first cavity or the second cavity. The one or more components include at least one of an emergency locator or beacon, a compass, an altimeter, a barometer, a thermometer, a pH sensor, a fitness tracker, a position sensor, an accelerometer or G meter, a heart monitor, a blood sugar monitor, a pulse oximeter, a location tag, a watch or internal clock, a laser pointer or targeting tool, a laser sight or distance measurement device, a mechanical sound emitter, or a hand warmer. At least some of the one or more components are operably connected to the control unit.

In some embodiments, the handheld tool is a folding blade knife, a fixed blade knife, a multi-tool, a box cutter, scissors, a saw, a drill, a hammer, a screwdriver, a ratchet, pliers, a wrench, snips, a level, a tape measurer, a shovel, a gardening or tree trimming tool, or a battery-operated power tool.

In another particular embodiment, a handheld tool that wireless receives power includes a handle defining a first cavity. The handheld tool includes an electrical system at least partially positioned in the first cavity. The electrical system includes a charge component for receiving power and transferring power to a power storage device, a control unit, and an activation device operably connected to the power storage device. The handheld tool includes a light pipe configured to illuminate with at least one color from at least one indicator light. The at least one color corresponds to an operational status of the charge component.

In some embodiments, the light pipe is positioned proximate to an aperture in the handle. In some embodiments, the aperture is a lanyard aperture. The light pipe forms a ring about an inner surface of the lanyard aperture.

In some embodiments, the light of at least one color includes a first color corresponding to a first operational status where a stored power level within the power storage device is below a first power level threshold, a second color corresponding to a second operational status where the stored power level within the power storage device is above a second power level threshold, and a third color corresponding to a third operational status where the power storage device is receiving power. In some embodiments, at least one color blinks intermittently at pre-determined time intervals.

In some embodiments, the handheld tool includes a lens positioned over the aperture. The at least one light is visible through the lens. The lens is fabricated from a plastic, a protective glass, or a glass with one or more focusing, magnifying, reflective, or refractive properties.

In another particular embodiment, a knife that wirelessly receives power includes a handle defining a first cavity. The knife includes an electrical system at least partially positioned in the first cavity. The electrical system includes a charge component for receiving power and transferring power to a power storage device, a control unit, and an activation device operably connected to the power storage device. The knife includes a light electrically connected to the electrical system.

In another particular embodiment, a handheld tool that wirelessly receives power includes a handle defining a first cavity and a second cavity. The handheld tool includes an electrical system at least partially positioned in the first cavity. The electrical system includes a charge component for receiving power and transferring power to a power storage device, a control unit, and an activation device operably connected to the power storage device. The handheld tool includes a device comprising at least one of a transmitter or a receiver, where the device is operably connected to the control unit and at least partially positioned within the first cavity or the second cavity, where the device is configured to transmit output data from the control unit, receive input data, and/or provide the input data to the control unit.

In some embodiments, the device including at least one of said transmitter or said receiver is configured to communicate with at least one of a computer system, personal electronic device, or intermediate server configured to execute one or more program instructions for a program or application including a user portal or dashboard configured for a user to view the transmitted output data, and further configured for services related to ownership, registration, and support of the handheld tool.

In some embodiments, the device including at least one of said transmitter or said receiver is configured to communicate data related to operational information of the handheld tool including power storage device level, power storage device charge rate and/or discharge rate, or a cycle count of components installed within the handheld tool.

In some embodiments, the device including at least one of said transmitter or said receiver is configured for Bluetooth. The control unit is configured to transmit the output data and receive the input data via Bluetooth.

In another particular embodiment, a knife that wirelessly receives power includes a handle defining a first cavity and a second cavity. The knife includes a blade. A portion of the blade is interconnected to the handle. The knife includes an electrical system at least partially positioned in the first cavity. The electrical system includes a charge component for receiving power and transferring power to a power storage device, a control unit, and an activation device operably connected to the power storage device. The knife includes one or more sensors. Each of the one or more sensors are at least partially positioned within the first cavity or at least a second cavity defined within the handle. Each of the one or more sensors are configured to collect sensor data and provide the sensor data to the control unit.

In some embodiments, the handle includes a first scale and a second scale that together define a channel positioned therebetween. The first scale defines the first cavity and the second scale defines the second cavity. The blade is pivotally interconnected to a forward end of the handle. The blade has a cutting edge. The blade being movable between a first closed position where the cutting edge is positioned in the channel and a second extended position where the cutting edge is positioned outside of the channel. In some embodiments, the charge component and the power storage device each have a substantially planar shape. The substantially planar shape of the power storage device, the charge component, and the scales are oriented in a plane.

In some embodiments, one or more sensors includes a power storage device sensor. The control unit is configured to regulate at least one of charging and discharging of the power storage device based on data received from the power storage device sensor.

In some embodiments, the knife includes a transmitter and receiver (TX/RX) unit. The device is operably connected to the control unit and at least partially positioned within the first cavity or the second cavity. The TX/RX unit is configured to transmit output data from the control unit, receive input data, and provide the input data to the control unit. The output data includes the sensor data. In some embodiments, the TX/RX unit is configured to communicate with at least one of a computer system, personal electronic device, or intermediate server configured to run a program or application including a user portal or dashboard a user to view the transmitted output data, and further configured for services related to ownership, registration, and support of the knife. In some embodiments, the control unit is configured to receive one or more signals to control the knife from a personal electronic device via the TX/RX unit. In some embodiments, the TX/RX unit is configured for Bluetooth. The control unit is configured to transmit the output data and receive the input data via Bluetooth.

In another particular embodiment, a knife that wirelessly receives power includes a handle with a first scale and a second scale that define a channel positioned therebetween. The first scale defines a first cavity. The second scale defines a second cavity. The knife includes an electrical system at least partially positioned in the first cavity or the second cavity. The electrical system includes at least one battery. The electrical system includes electronics housed on boards with communication traces running to the at least one battery. A discharge of the at least one battery is regulated by the electronics. The electrical system includes at least one light configured to illuminate a portion of an external environment surrounding the knife. The electrical system includes a Bluetooth antenna. The knife includes a blade at least partially positioned in the handle. The blade is pivotally interconnected to a forward end of the handle. The blade has a cutting edge. The blade is movable between a first closed position where the cutting edge is positioned in the channel and a second extended position where the cutting edge is positioned outside of the channel. The arrangement of the electrical system and the blade provides a radiation path with a reduced level of obstruction for at least one of receiving and transmitting data via the Bluetooth antenna.

In some embodiments, the knife includes at least one indicator light configured to indicate at least one operational status of the knife. The at least one indicator light is configured to pass through a light pipe at a first end. A second end of the light pipe is positioned on an external surface of the handle. The at least one operational status includes a charge level of the battery monitored by the electronics. In some embodiments, the at least one indicator light includes three light emitting diodes configured to provide light communicating the at least one operational status of the knife. The at least one light includes two lights.

In some embodiments, the blade is held in at least one of the first closed position or the second extended position via a locking mechanism. In some embodiments, the locking mechanism comprises a detent.

In some embodiments, the blade is positioned to prevent interference of the at least one of receiving and transmitting data via the Bluetooth antenna by reducing the blade operating as a reflector or a ground plane.

In some embodiments, the control unit is configured to receive one or more signals to control the knife from a personal electronic device via the Bluetooth antenna. In some embodiments, the control unit is configured to couple to at least one user interface. The at least one user interface is operable to receive one or more user inputs. The at least one user interface is operable to generate one or more aural outputs. The one or more aural outputs are provided to a user via at least one of the Bluetooth antenna, a headphone jack, or an audio speaker.

In some embodiments, the knife includes a device with a transmitter or a receiver in addition to the Bluetooth antenna. The device is operably connected to the control unit and at least partially positioned within the first cavity or the second cavity. The device is configured to transmit output data from the control unit, receive input data, and/or provide the input data to the control unit. At least one of the Bluetooth antenna and the device is configured to communicate with a computer system, personal electronic device, or intermediate server configured to run a program or application including a user portal or dashboard for a user to view the transmitted output data.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.”

The term “a” or “an” entity, as used herein, refers to one or more of that entity. As such, the terms “a” (or “an”), “one or more” and “at least one” can be used interchangeably herein. It will be appreciated that with the position of the blade or folding knife, “open” may be used herein interchangeably with “extended.”

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts, and the equivalents thereof, shall include all those described in the summary, brief description of the drawings, detailed description, abstract, and claims themselves.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and Detailed Description and no limitation as to the scope of the present disclosure is intended by either the inclusion or non-inclusion of elements, components, etc. in this Summary. Additional aspects of the present disclosure will become more readily apparent from the Detailed Description particularly when taken together with the drawings.

It is to be appreciated that any feature described herein can be claimed in combination with any other feature(s) as described herein, regardless of whether the features come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1A shows a front perspective view of a folding knife with a blade in a closed position according to an embodiment of the present disclosure;

FIG. 1B shows a front perspective view of the folding knife in FIG. 1A with the blade in an open position according to an embodiment of the present disclosure;

FIG. 2 shows a rear perspective view of the folding knife in FIG. 1A according to an embodiment of the present disclosure;

FIG. 3A is a bottom plan view of a handle of the folding knife in FIG. 1A according to an embodiment of the present disclosure;

FIG. 3B is a bottom plan view of a handle of another folding knife according to an embodiment of the present disclosure;

FIG. 3C is a bottom plan view of a folding knife in the open position according to an embodiment of the present disclosure;

FIG. 4A is a rear elevation view of the first scale of a handle of a folding knife according to an embodiment of the present disclosure;

FIG. 4B is a perspective view of the first scale of the handle in FIG. 4A;

FIG. 5A is a front elevation view of a second scale of a handle of a folding knife according to an embodiment of the present disclosure;

FIG. 5B is a perspective view of the second scale of the handle in FIG. 5A;

FIG. 5C is a front elevation view of a scale of a handle of a folding knife according to an embodiment of the present disclosure;

FIG. 6A is a rear elevation view of electronic components for a folding knife according to an embodiment of the present disclosure;

FIG. 6B is a rear elevation view of the electronic components in FIG. 6A positioned in a first scale of folding knife according to an embodiment of the present disclosure;

FIG. 6C is a rear elevation view of electrical components positioned in the handle of a tool according to an embodiment of the present disclosure;

FIG. 6D is a rear elevation view of electronic components for a folding knife according to an embodiment of the present disclosure;

FIG. 6E is a rear elevation view of the electronic components in FIG. 6D positioned in the handle of a tool according to an embodiment of the present disclosure;

FIG. 7A is a bottom elevation view of a folding knife positioned on a charge base according to an embodiment of the present disclosure, where FIG. 7A is a side elevation view of the charge base;

FIG. 7B is a bottom elevation view of another folding knife positioned on a charge base according to an embodiment of the present disclosure, where FIG. 7B is a side elevation view of the charge base;

FIG. 7C is a bottom elevation view of a further folding knife positioned on a charge base according to an embodiment of the present disclosure, where FIG. 7C is a side elevation view of the charge base;

FIG. 7D is a bottom elevation view of another folding knife positioned on a charge base according to an embodiment of the present disclosure, where FIG. 7D is a side elevation view of the charge base;

FIG. 7E is a bottom elevation view of a tool and a charge base according to an embodiment of the present disclosure, where FIG. 7E is a side elevation view of the charge base;

FIG. 8 is a flow chart for operation of a folding knife positioned on a charge base according to an embodiment of the present disclosure;

FIG. 9A is a front perspective view of an embodiment of a folding knife according to an embodiment of the present disclosure;

FIG. 9B is a rear perspective view of the folding knife in FIG. 9A;

FIG. 9C is an exploded view of the folding knife in FIG. 9A;

FIG. 10A is a front elevation view of the folding knife in FIG. 9A;

FIG. 10B is a side elevation view of the folding knife in FIG. 9A;

FIG. 10C is a top plan view of the folding knife in FIG. 9A;

FIG. 10D is a bottom plan view of the folding knife in FIG. 9A;

FIG. 11A is a schematic of a folding knife according to an embodiment of the present disclosure;

FIG. 11B is a schematic of another folding knife according to an embodiment of the present disclosure;

FIG. 11C is a schematic of a system including the folding knife according to an embodiment of the present disclosure; and

FIG. 11D is a schematic of another system including another folding knife according to an embodiment of the present disclosure.

To provide further clarity to the detailed description provided herein in the associated drawings, the following list of components and associated numbering are provided as follows:

| Component No. | Component |
|---|---|
| 2 | Folding Knife |
| 6 | Blade |
| 10 | Spine |
| 14 | Thumb Traction Surface |
| 18 | Aperture |
| 22 | Handle |
| 26 | First Scale |
| 30 | Pivot Point |
| 34 | Lock Feature |
| 38 | Lanyard Aperture |
| 42a, 42b, 42c, 42d | Light or Bulb |
| 46 | Activation Device |
| 50 | Tip |
| 54 | Cutting Edge |
| 58 | Choil |
| 62 | Clip |
| 66 | Second Scale |
| 70 | Channel |
| 74 | Channel Width |
| 78a, 78b | Storage Cavity |
| 82 | Reinforcement Area |
| 86a, 86b, 86c | Storage Channel |
| 90 | Charge Cavity |
| 94 | Lock Aperture |
| 98 | Pivot Recess |
| 102a, 102b | Light Recess |
| 106a, 106b | Light Channel |
| 110a, 110b, 110c | Activation Aperture |
| 114a, 114b, 114c | Activation Channel |
| 118a, 118b | Arm |
| 122 | Rib |
| 126 | Cutout Area |
| 128 | USB Drive |
| 130 | Back Portion |
| 134, 134a, 134b, 134c, 134d | Power Storage Device |
| 138, 138a, 138b | Control Unit |
| 142, 142a, 142b | Charge Component |
| 146a, 146b, 146c | Power Wire |
| 150a, 150b | Light Wire |
| 154a, 154b, 154c | Activation Wire |
| 155a, 155b | Electrical System |
| 156 | Indicator Light |
| 157 | Orientation Sensor |
| 158 | Charge Base |
| 160 | Bottom Surface of Charge Base |
| 161 | Upper Surface of Charge Base |
| 162 | Charge Component |
| 166 | Protrusion |
| 170 | Wing |
| 174 | Wing Height |
| 178 | Knife Width |
| 182 | Position Sensor |
| 186 | Shield |
| 190 | First Offset |
| 194 | Second Offset |
| 198 | Position Knife |
| 202 | Receive Power |
| 206 | Determine Status |
| 210 | Cease Reception |
| 214 | Provide Indication |
| 218 | Permit Reception |
| 222 | Provide Indication |
| 224a, 224b | Folding Knife |
| 226 | Blade |
| 228 | Handle |
| 230a, 230b | Washer |
| 232a, 232b | Liner |
| 234 | Back Spacer |
| 236 | Ball Holder |
| 238 | Bearing Ball |
| 240 | Spring |
| 244 | Screw |
| 246 | Clip |
| 250 | Scale |
| 252 | Substrate |
| 253 | Control Device |
| 254a, 254b | Electrode |
| 256 | Light Pipe |
| 258a, 258b | Battery |
| 260a, 260b | Button |
| 262a, 262b | Light |
| 264 | Scale |
| 266 | Handle Length |
| 268 | Blade Length |
| 270 | Handle Width |
| 272 | Components |
| 274 | Sensors |
| 276 | Processors |
| 278 | Memory |
| 280 | User Interface |
| 282 | Display |
| 284 | User Input Devices |
| 286 | Aural Output Devices |
| 288 | Haptic Output Devices |
| 290 | Visual Input Devices |
| 291 | Computer System or Personal Electronic |
| | Device (PED) |
| 292 | Intermediate Server |
| 294 | System |
| 296 | Transmitter/Receiver/Transceiver Unit |

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

As described in detail below, various embodiments of the present disclosure include novel folding knife designs and configurations, comprising a sealed power storage device and charge component and/or other features or devices. The present disclosure has significant benefits across a broad spectrum of endeavors.

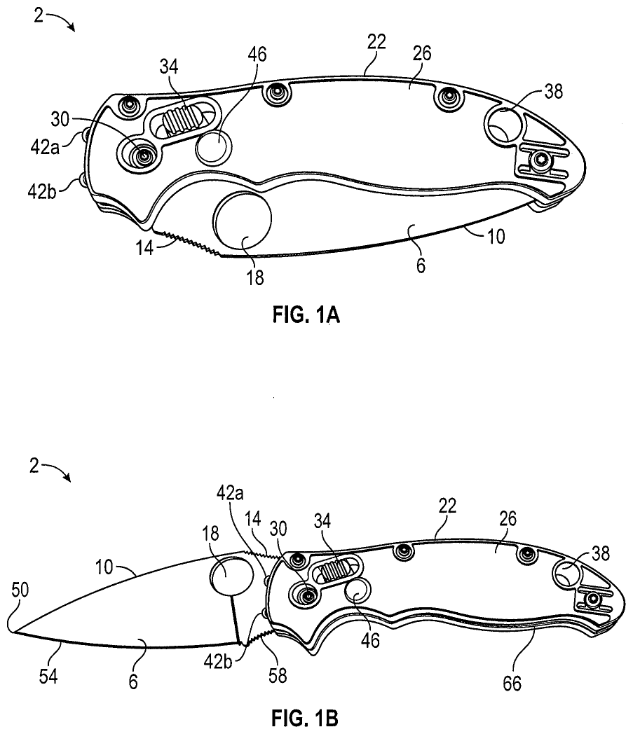

Referring now to FIGS. 1A and 1, front perspective views of a folding knife 2 in a closed position and an open position, respectively, are provided. The folding knife 2 generally has a handle 22 and a blade 6 that rotates relative to the handle 22 between the closed position and the open position. As shown, the blade 6 has a spine 10, a cutting edge 54, and a tip 50 positioned at a distal end of the blade 6 between the spine 10 and the cutting edge 54. The blade 6 can have further features such as a thumb traction surface 14 and a coil 58 that provide enhanced grip surfaces for a user. The blade 6 also has an aperture 18. A user can rotate the blade 6 about a fixed pivot pin 30 from the closed position to the open position. The blade 6 is typically metal, but can be any known material such as ceramic, fiberglass, or plastic.

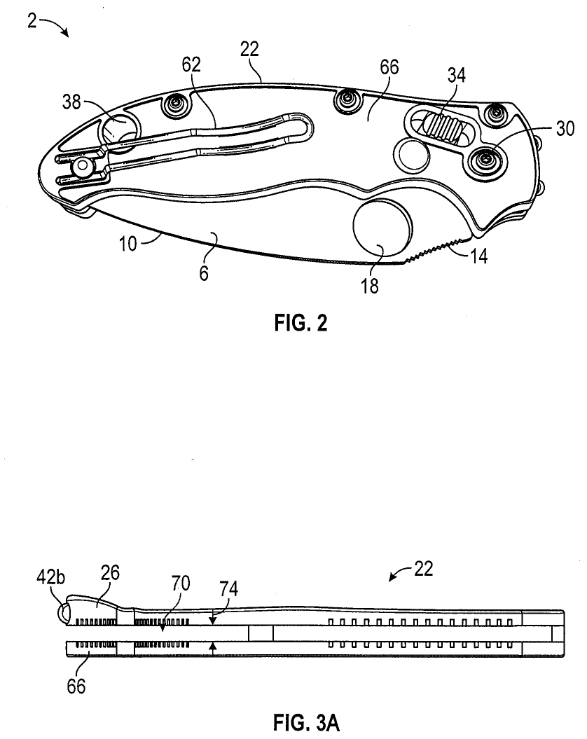

The handle 22 has a first scale 26 and a second scale 66, which is better shown in FIG. 2. The handle 22 also has a lock device 34 that can selectively lock the blade 6 in one or both of the open position and the closed position. The handle 22 further comprises a lanyard aperture 38 through both scales 26, 66 where a user can connect a lanyard or other similar device to carry or secure the folding knife 2. The handle 22 and scales 26, 66 can be composed of various materials known in the art, for example, wood, metal, composite material, fiberglass, plastic, etc. The scales 26, 66 can be made of a material that promotes the wireless charging of the folding knife 2. In one embodiment, the scales 26, 66 are made from a plastic that allows an electromagnetic wave to reach electronic components within the scales 22, 66. In other embodiments, the scales 22, 66 can comprise a shield that prevents the free transmission of electromagnetic waves except for the electronic components related to the wireless transmission of electrical energy.

In one embodiment, a first light or bulb 42a and a second light or bulb 42b are positioned at a forward end of the handle 22, and an activation device 46 such as a button can activate the lights or bulbs 42a, 42b. The lights 42a, 42b illuminate the area (e.g., a portion of an external environment surrounding the handle 22 and/or in which the handle 22 is positioned) in front of the folding knife 2 to assist with a cutting or thrusting action of the blade 6. Pressing the activation device 46 can cause the lights 42a, 42b to illuminate in different ways and in different combinations. For instance, pressing the activation device 46 can cycle the lights 42a, 42b through multiple modes of operation, which can include activating only one light 42a, 42b, activating both lights 42a, 42b, activating one or both lights 42a, 42b with different colors, pulsing one or both lights 42a, 42b to produce a strobe effect, activating one or both lights 42a, 42b with a brighter or less bright intensity, etc. In addition, holding the activation device 46 for a predetermined amount of time (e.g., is, 2s, 3s, etc.) can cause the lights 42a, 42b to activate in a yet a further or alternative mode or modes of operation.

It will be appreciated that while two lights or bulbs 42a, 42b are depicted, embodiments of the present disclosure encompass a greater or fewer number of lights or bulbs 42a, 42b or other devices. In addition, one light 42a can be positioned on one scale and the other light 42b can be positioned on the other scale. One light 42a can emit, for example, a red light, and one light 42b can emit, for example, a white light. Moreover, embodiments of the present disclosure encompass other devices and features such as a light, a locking mechanism, an opening mechanism, a microphone, an audio speaker, a GPS beacon or device, an altimeter, a compass, environment sensors (e.g., barometers, thermometers, hygrometers, air quality sensors including oxygen level, carbon dioxide level, carbon monoxide level, smoke, or the like), a fitness tracker, a heart monitor, a blood sugar monitor, a transmitter, a receiver, a transceiver, a pH sensor, a position sensor, a hand warmer, a vibrating mechanism, a camera or video recorder, a communication device, a clock, a data storage device with an interface such as USB, memory card, or other flash drive medium, and a data storage device managed or interfaced through a wireless data protocol, etc. In embodiments that comprise a USB interface, the data storage device can be stored in one of the cavities defined by the handle, and a USB receptable (e.g., USB 1.0, USB 1.1, USB 2.0, USB 3.0, USB-C, or the like) and/or plug (e.g., including, but not limited to, a magnetic connector or a non-magnetic connector) can be positioned at a surface of the handle. In addition, the data storage device with the USB interface may be removable from or insertable into the handle. In embodiments that comprise a memory card, the handle 22 may include a memory card slot leading to a memory card receptacle configured to receive a secure digital (SD) memory card, microSD card, or other flash drive medium. In embodiments that comprise a data storage device managed through wireless protocol, the data storage device may be configured for any known data transmitting and receiving protocol known in the art. In one non-limiting example, the protocol may be any wireless data protocol usable with handheld devices including, but not limited to, Bluetooth. Moreover, embodiments of the present disclosure can include rubber covers that protect the receptable and/or plug to preserve the air and/or fluid seal within the handle. It will be further appreciated that the activation device 46 can be a button, a switch, a slider switch that moves between more than two positions, a touch screen with pressure sensors, a fingerprint sensor, a microphone that receives voice commands, etc.

In some embodiments, the plug or other receptacle may be usable for charging, for dispersing or providing power to external devices (e.g., is operable as a powerbank), and/or for data transmitting or receiving by devices within the handle 22, allowing a user to operate, command, and/or otherwise interact with or store data to and/or from an external accessory. For example, a data storage device within the handle 22 may be accessible via the plug or other receptable. By way of another example, devices including, but not limited to, a GPS beacon or device, an altimeter, a compass, environment sensors (e.g., barometers, thermometers, hygrometers, air quality sensors including oxygen level, carbon dioxide level, carbon monoxide level, smoke, or the like), a fitness tracker, a heart monitor (e.g., a heart rate and/or pulse rate sensor), a blood sugar monitor (e.g., a blood sugar sensor), a transmitter, a receiver, a transceiver, a pH sensor, a position sensor, a camera or video recorder, or the like may transmit and/or receive data via the plug or other receptacle. It is noted at least some, or all in some embodiments, of the data transmitting and receiving with the handle 22, however, may be completed via wireless communication.

Referring now to FIG. 2, a rear perspective view of the folding knife 2 is provided. Specifically, the second scale 66 of the handle 22 is shown, and a clip 62 is provided that can secure the folding knife 2 in a pocket, a belt, or other location. The clip can be positioned on either the first scale 26 or the second scale 66. FIG. 2 also shows the reverse side of the blade 6, the lock device 34, and the lanyard aperture 38.

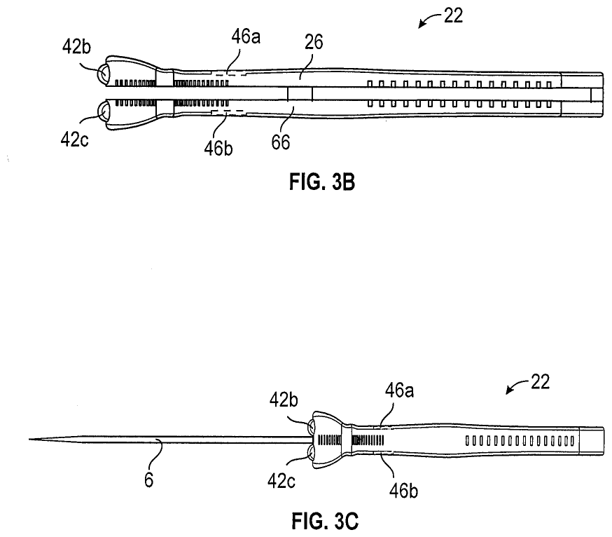

Referring now to FIG. 3A, a bottom plan view of the handle 22 of the folding knife is provided. The first scale 26 and the second scale 66 define a channel 70 that receives the blade when the blade is in the closed position. In other words, the cutting edge of the blade is positioned in the channel 70 when the blade is in the closed position, and the cutting edge of the blade is position outside of the channel 70 when the blade is in the open position. In this view, the channel 70 has a channel width 74. The blade, the first scale 26, and the second scale 66 have substantially planar shapes to preserve the ergonomics and functionality of the handle 22 and the folding knife 2. Thus, the channel width 74 can be on the order of the thickness of one or both of the first scale 26 and the second scale 66 in some embodiments.

Referring now to FIG. 3B, a bottom plan view of the handle 22 of a knife or tool is provided. Each scale 26, 66 of the handle 22 has a complete electrical system including at least one light 42b, 42c at a forward end of the scale 26, 66. In addition, each scale 26, 66 has a power storage device, a control unit, a charge component, and an activation device 46a, 46b. In some embodiments, the electrical system in each scale 26, 66 can be completely isolated and independent from each other. In other embodiments, the electrical systems in each scale 26, 66 are connected and operate together for redundancy. Thus, one charge component can charge all power storage devices of all electrical systems in the handle 22, and a given power storage device can power all lights 42b, 42c. In addition, the knife may include the necessary components or circuitry to charge external devices with the power storage devices (e.g., the knife is operable as a powerbank) via a wired connection (e.g., with a plug) or wireless connection (e.g., inductive charging). For example, the external device may include, but is not limited to, a personal electronic device (e.g., a phone, tablet, smartwatch, or the like), rechargeable flashlight, GPS device, or the like.

As noted above, each scale 26, 66 has an activation device 46a, 46b, and the activation devices 46a, 46b can operate the lights 42b, 42c in a number of ways. For example, in one embodiment, the activation device 46a on the first scale 26 controls the light 42b or plurality of lights 42b on the first scale 26. A user can engage the activation device 46a to cycle through a series of modes of operation for the light 42b or plurality of lights 42b such as: turning on one light 42b, turning on multiple lights 42b, flashing one or more lights 42b, changing the color of the light(s) 42b, 42c, turning off one or more lights 42b, etc. A user can engage the other activation device 46b to cycle through a similar series of modes of operation for the other light 42c or plurality of lights 42c.

In other embodiments, having each side of the knife or tool with lights and activation devices provides flexibility for a user. For example, the knife or tool may be available only to a particular hand, such that the user may be limited as to which side of activation devices may be used. By way of another example, the knife or tool may be configured for either handedness of the user. By way of another example, a clip or other retaining feature may be positioned across one of the scales 26, 66 and possibly obscuring a light and/or activation device. In some embodiments, the electrical systems are connected and operate with each other, and each activation device 46a, 46b can control both lights 42b, 42c or pluralities of lights 42b, 42c. Engaging one of the activation devices 46a, 46b can cycle through modes of operation such as: turning on one light 42b, 42c, turning on both lights 42b, 42c, turning off one light 42b, 42c, changing the color of the light(s) 42b, 42c, turning off both lights 42b, 42c, etc.

Regardless of whether the multiple electrical systems are separate or connected, a user can engage each activation device 46a, 46b in different ways such as pressing the activation device 46a, 46b, double-clicking the activation device 46a, 46b, pressing and holding the activation device 46a, 46b, etc. These different ways of engaging the activation device 46a, 46b can be used to manipulate the lights 42a, 42b in different ways. For example, pressing one activation device 46a will cycle through modes of operation for one light 42b or set of lights 42b, and double-clicking the same activation device 46a will cycle through modes of operation for another light 42c or set of lights 42c. Alternatively or in addition, double-clicking the same activation device 46a will cycle through a second set of modes of operation for one light 42b or set of lights 42b. Pressing the activation device 46a, 46b means pressing the activation device 46a, 46b only once in a predetermined time period, double-clicking means pressing an activation device 46a, 46b multiple times within the predetermined time period, and holding the activation device 46a, 46b means pressing and holding the activation device 46a, 46b for longer than the predetermined time period.

The lights 42b, 42c can also have different colors and can encompass any electromagnetic radiation-emitting device. For instance, in one embodiment, one light 42b or set of lights 42b emits white light and the other light 42c or set of lights 42c emits red light, and one activation device 46a is operably connected to only one light 42b or set of lights 42b and another activation device 46b is operably connected to only the other light 42c or set of lights 42c. In a further embodiment, both lights 42b, 42c or sets of lights 42b, 42c are one color, such as white, and each activation device 46a, 46c is operably connected to all lights 42b, 42c for redundancy. Further still, embodiments can incorporate infrared lights and/or any device that emits electromagnetic radiation such as lasers.

It will be appreciated that while the lights 42b, 42c are depicted at a forward end of the handle 22, the lights 42b, 42c can be located at any positioned on the handle 22 and/or can include a plurality of lights that form a screen on an outer surface of the handle 22.

Referring now to FIG. 3C, a bottom plan view of a knife with a handle 22 and with a blade 6 is provided. In this embodiment, the knife is a fixed blade knife and the handle 22 does not have a channel to receive a rotating blade. Instead, the handle 22 can be made from a solid material or even from multiple scales joined together without a channel. The handle 22 in FIG. 3C has a light 42b, 42c or sets of lights 42b, 42c on each side of the blade 6, and the lights 42b, 42c are operable with the activation devices 46a, 46b as described above with respect to FIG. 3B. While knives are depicted in the figures, embodiments of the present disclosure can apply to any tool.

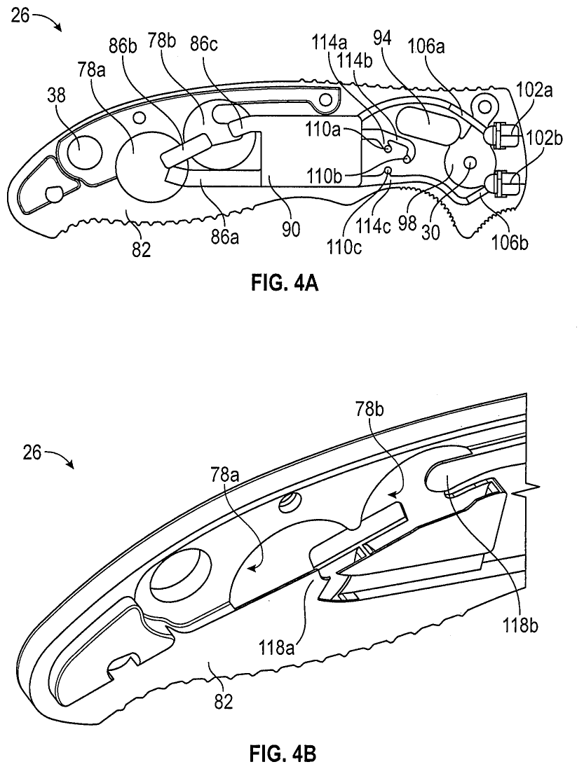

Referring now to FIGS. 4A and 4B, a rear elevation view and a perspective view of an inner surface of the first scale 26 are provided, respectively. A power storage device, a charge component, an activation device, and a device such as a light are arranged in the first scale 26. Corresponding cavities, recesses, and channels extend into the inner surface of the first scale 26 to provide space for these components but are also strategically chosen to leave a remaining reinforcement area 82 that provides strength and stiffness to the first scale 26 and the folding knife.

Two storage cavities 78a, 78b extend into the first scale 26 to receive power storage devices, which can be batteries with planar shapes, e.g., disks or flat cylinders. Instead of a single battery with a thickness that is too large for the first scale 26, two or more separate batteries can each have a smaller thickness that allows for the batteries to be positioned in the first scale 26 while maintaining the planar ergonomics of the scale 26 and the folding knife. It will be appreciated that the power storage device can be a capacitor or other storage devices and, in addition, the folding knife can have a single storage cavity 78, more than two storage cavities 78, or even a combined cavity in various embodiments. FIG. 4B shows arms 118a, 118b that at least partially extend over an area of the respective storage cavities 78a, 78b. The arms 118a, 118b help retain the batteries inserted into the cavities 78a, 78b and can deflect as the batteries are positioned in place in the cavities 78a, 78b. When a liner, a backspacer, a second scale or other component is secured over the inner surface of the first scale 26, the arms 118a, 118b can effectively lock the power storage devices in the cavities 78a, 78b. Moreover, the arms 118a, 118b can have electric contacts to transfer power between the power storage devices and other components within the handle. In this regard, the power storage devices may be batteries, capacitors, or the like and/or can be either integrated into the knife or removable from the knife. For example, the power storage devices may be charged when installed in the knife (e.g., as rechargeable batteries or capacitors), either via wired connection (e.g., a plug) or via wireless or remote connection (e.g., inductive charging). By way of another example, the power storage devices may be removable and charged remotely with a cradle or other battery charger. By way of another example, the power storage devices may be replaceable, such as a one-time-use battery configured to fit within and make contact with leads in a defined cavity.

Next, a control cavity 90 extends into the inner surface of the first scale 26 to receive a control unit such as a circuit board as well as a charge component such as an inductive coil, a resonator coil, or an RF antenna. In some embodiments, the storage cavity 78 and the control cavity 90 can be combined into a single cavity. Also shown in FIG. 4A are three activation apertures 110a, 110b, 110c that extend through the first scale 26. These apertures 110a, 110b, 110c allow a portion of the activation device to extend between the outer and inner surfaces of the first scale 26 to send a signal to other components within the folding knife. The three apertures 110a, 110b, 110c are arranged below the activation device so that if the activation device is pressed asymmetrically, then at least one part of the device will register the pressing action and transmit a signal through one of the apertures 110a, 110b, 110c. Two recesses 102a, 102b are positioned at the forward end of the first scale 26, and these recesses 102a, 102b receive the two lights 42a, 42b shown in FIGS. 1A and 1B, or other devices in other embodiments.

Several other recesses and apertures are shown in FIG. 4A. A pivot recess 98 receives part of the blade, typically the tang of the blade, and is centered about the pivot point 30 of the blade. A lock aperture 94 extends through the first scale 26 to receive components of the locking device. The lanyard aperture 38 is also depicted.

Several channels extend into the inner surface of the first scale 26 to link the various components of the folding knife together, and the channels are strategically located to leave the remaining reinforcement area 82 that provides strength and stiffness to the first scale 26 and the folding knife. A first storage channel 86a extends between the control cavity 90 to the first storage cavity 78a, a second storage channel 86b extends between the two storage cavities 78a, 78b, and a third storage channel 86c extends from the second storage cavity 78b to the control cavity 90. These channels 86a, 86b, 86c can route wires, electric contacts, or otherwise provide electrical communication between the power storage devices and the control unit and/or charge component.

Three activation channels 114a, 114b, 114c extend from respective activation apertures 110a, 110b, 110c to the control cavity 90 to route wires, electric contacts, or otherwise provide electrical communication between the activation device and the control unit and/or charge component. Two device or light channels 106a, 106b extend from respective recesses 102a, 102b to the control cavity 90 to route wires, electric contacts, or otherwise provide electrical communication between a device such as a light and the control unit and/or charge component.

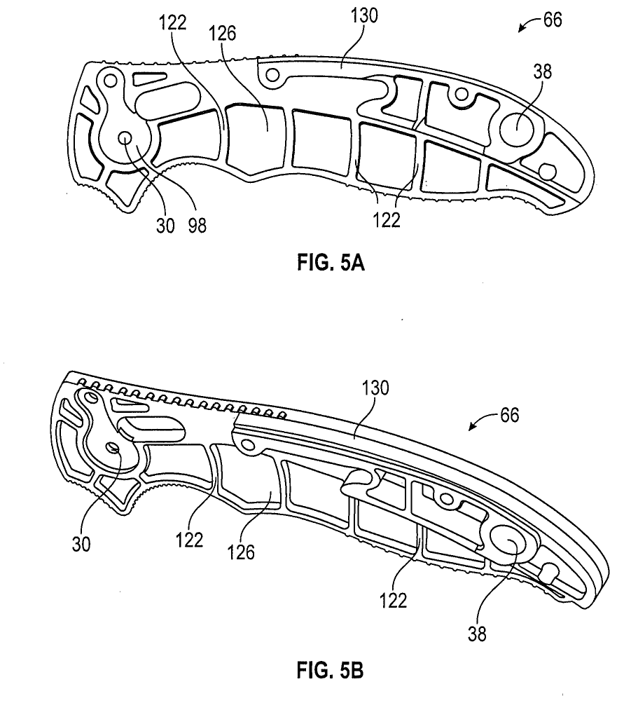

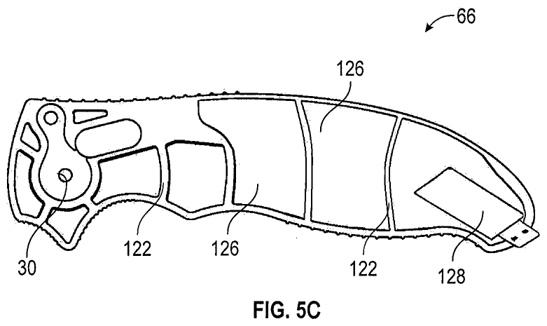

The first light channel 106a extends between the lock aperture 94 and a top edge of the inner surface to leave the remaining reinforcement area 82 on either side of the first light channel 106a. Two activation channels 114a, 114b merge together, but a remaining reinforcement area 82 is positioned between the merged channels 114a, 114b and the first light channel 106a. Likewise, the second light channel 106b and the third activation channel 114c merge together but leave a remaining reinforcement area 82 on either side of the merged channel. These reinforcement areas 82 provide stiffness and strength to the first scale 26 much like a reinforcing rib as described below with respect to the second scale 66 shown in FIGS. 5A and 5B.

Referring now to FIGS. 5A and 5B, a front elevation view and a perspective view of an inner surface of the second scale 66 are provided, respectively. Like the first scale, the second scale 66 also has a lanyard aperture 38 and a pivot recess 98 at the forward end where the blade is located, specifically the tang of the blade. The second scale 66 also has a back portion (also called a “back spacer” or “backspacer”) 130 that establishes the width of the channel between the scales in this embodiment. Also shown in FIGS. 5A and 5B are the system of cutout areas 126 and ribs 122. The cutout areas 126 remove weight and mass from the second scale 66 and the remaining ribs 122 provide stiffness and strength to the second scale 66. In general terms, the cutout areas 126 can correspond to the cavities, recesses, and channels like the first scale, and the ribs 122 can correspond to the reinforcement area of the first scale. However, the cutout areas 126 and ribs 122 in the second scale 66 are more optimized to maximize the cutout areas 126 and minimize the area of the ribs 122 since the components and wires are not housed in the second scale 66 in this embodiment. In other words, the cavities, recesses, and channels in the first scale must accommodate the sizes and shapes of the various components before optimizing to reduce mass and maintain strength and stiffness. This difference between the first scale and the second scale is further shown by the combined area of the cutout areas 126 in the second scale 66 being greater than the combined area of the cavities, recesses, and channels of the first scale. Conversely, the combined area of the ribs 122 is smaller than the reinforcement areas in the first scale.

In some embodiments, the second scale 66 can include one or more power storage devices to augment the power storage devices in the first scale. In one exemplary embodiment, the second scale 66 has one or more cavities that receive one or more power storage devices, such as batteries or capacitors. A wire can extend from the power storage devices in the second scale 66 to the electrical components in the first scale to supply and receive power from the electrical components. For instance, the wire can extend to the power storage devices in the first scale such that all power storage devices of the folding knife collectively work together to store power from the charge component. In some embodiments, the power storage devices in the second scale 66 can connect to the control unit or the charge component to serve as a back-up power reserve. In addition, in some embodiments, a backspacer, liner, electrical contacts, etc. operably connect the power storage devices in the second scale 66 to electrical components in the first scale. Alternatively, the backspacer 130 can have a channel through which wires or electrical connectors run from the first scale 26 to the second scale 66. In various embodiments, the second scale 66 itself is a power storage device to completely utilize the mass and space of the second scale 66 for storing power. The power storage device can have the pivot recess 98, the backspacer 130, and the lanyard aperture 38 to function as the second scale 66.

Referring now to FIG. 5C, a front elevation view of an inner surface of a scale 66 is provided. Specifically, the scale 66 is a second scale 66 that complements a first scale of a handheld tool. Like the embodiment shown in FIGS. 5A and 5B, the scale 66 in FIG. 5C has a pivot point 30, a plurality of ribs 122, and a plurality of cutout areas 126. In addition, one of the cutout areas 126 receives a universal serial bus (USB) drive, which comprises a receptacle for selectively interconnecting to another device and comprises a data storage device for storing information. The receptacle can move between positions where, in a first position, the receptacle is retracted within a volume defined by the scale 66. In a second position, at least a portion of the receptacle extends beyond the scale's volume to selectively interconnect with another device to send and receive data. It will be appreciated that other devices can be received in the cutout areas 126 as described elsewhere herein.

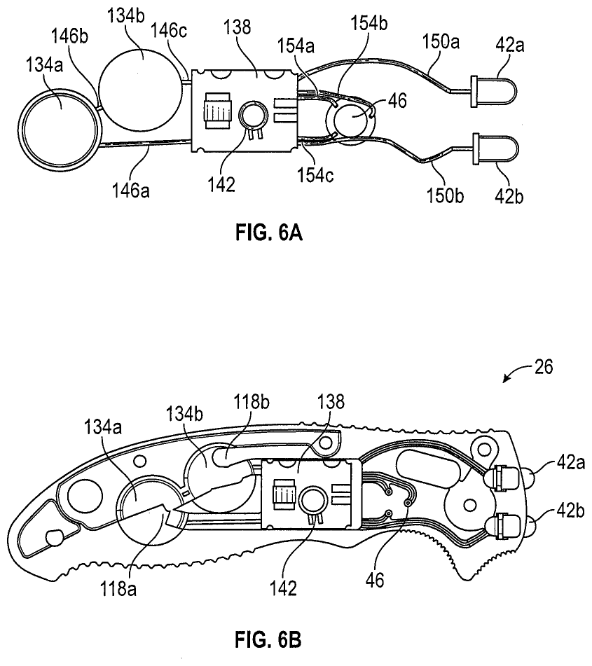

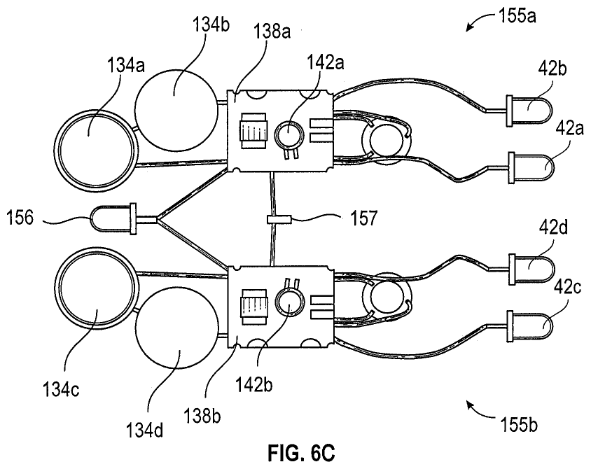

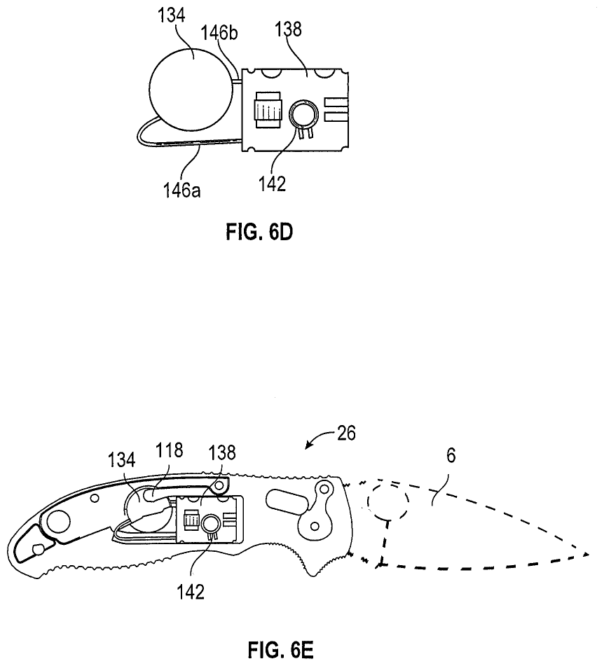

Referring now to FIGS. 6A and 6B, rear elevation views of the various components of the folding knife are provided. As shown in FIG. 6A, the folding knife has a control unit 138, which is a circuit board in this embodiment, and a charge component 142, which is an inductor coil in this embodiment. Storage wires 146a, 146b, 146c link the power storage devices 134a, 134b to the control unit 138 and charge component 142. When the folding knife is in the presence of another charge component, power can be wirelessly transmitted to the charge component 142, which charges and recharges the power storage devices 134a, 134b. In this embodiment, the power storage devices 134a, 134b are CR1616 batteries that have a thickness of 1.6 mm and a diameter in the planar direction of 10 mm. Therefore, in some embodiments, the ratio of the thickness to the maximum width in the planar direction can be between eight and twelve, or eight, nine, ten, eleven, or twelve. In various embodiments, the ratio is greater than eight. Activation wires 154a, 154b, 154c link the activation device 46 to the control unit 138, and light wires 150a, 150b link the lights 42a, 42b to the control unit 138. In some embodiments, a charge wire can connect to electrical components in the first scale to power the power storage devices 134a, 134b from an external power source. A socket at an outer surface of the first scale can receive a plug to connect the charge wire to the external power source, and a rubber stop can be positioned in the socket when the charge wire is not in use to prevent water, moisture, dirt, or other external elements from penetrating the interior of the first scale.

FIG. 6B shows the various components positioned in the cavities, recesses, and channels of the first scale 26 of the folding knife. The control unit 138, the charge component 142, and the power storage devices 134a, 134b can be sealed from external elements individually or in a single enclosed volume. The components are sealed to prevent fluid, whether gas or liquid, and dirt from moving between the enclosed volume and outside of the enclosed volume. Sealants, glues, rubber, gaskets, o-rings, epoxies, and other similar materials can provide the desired seal.

Referring now to FIG. 6C, a further embodiment of electrical components with two electrical systems 155a, 155b is provided. Each electrical system 155a, 155b is the same or similar to other systems described herein, including the system described in FIGS. 6A and 6B. The two electrical systems 155a, 155b are laid open in a common plane in FIG. 6C, but it will be appreciated that the electrical systems 155a, 155b positioned in the handle of a tool would be generally oriented on two planes that are parallel to each other with one electrical system 155a in one plane and the other electrical system 155b in the other plane, either in the same scale or one electrical system 155a in one scale and the second electrical system 155b in the second scale.

As shown, an indicator light (or lights) 156 and an orientation sensor 157 are each operably connected to the control unit for each electrical system 155a, 155b. The indicator light 156 can emit a light or specific colored light depending on the status of various aspects of the tool such as the quantity or amount of charge of one or more of the power storage devices 134a, 134b, 134c, 134d. For example the indicator light 156 may include a light emitting diode (LED) or other light generation device known in the art.

The indicator light 156 can be a single light in some embodiments that emits light into an aperture or light pipe (e.g., fiber optic cable, or the like) that extends through the handle such as the lanyard aperture. In some embodiments, the indicator light 156 may be visible through a lens (e.g., fabricated from plastics, sapphire, protective glass, glass with selected focusing, magnifying, reflective, or refractive properties, or the like) positioned proximate to or over the aperture in the handle 22. Thus, light from the indicator light 156 is visible from both sides of the handle. Mounting the indicator light 156 behind a light pipe and/or a lens may allow directed and/or assisted projection of illumination from the indicator light 156. In addition, mounting the indicator light 156 behind a light pipe and/or a lens may allow for remotely housing the lights within the handle 22 to manage component arrangement and spacing within the handle 22, which may result in a better balancing of heat generation throughout the handle 22 while also providing a cleaner, more stylish integration of the light 156 into the handle 22 profile while also protecting the light 156 from exterior elements.

In general, the folding knife or tool as described throughout the present disclosure may be configured to address heat generation within the handle 22 profile. For example, components that generate heat within the folding knife may be arranged (e.g., spaced, stacked, or the like) to balance or distribute heat generation throughout the folding knife. By way of another example, the folding knife may include components or methods (e.g., heat sinks, airflow apertures or channels, or the like) to remove heat from components (e.g., electronics, lights or bulbs, or the like) within the folding knife, preventing issues of overheating leading to slowed performance or increased rate of component deterioration. By way of another example, the folding knife may include components or methods to direct heat to components (e.g., temperature sensors, heat sinks, etc.) within the folding knife.

In one embodiment, the indicator light 156 is a dimmable light where the intensity of the light corresponds to the amount of charge in the one or more power storage devices 134a, 134b, 134c, 134d. A brighter light corresponds to more charge. In some embodiments, the indicator light 156 will emit a light with a first intensity that corresponds to a first quantity of charge of the power storage device. Then, the indicator light 156 will emit the light with a lesser second intensity that corresponds to a lesser second quantity of charge of the power storage device. In various embodiments, the indicator light 156 will emit a light with a first color, such as green, that corresponds to a first quantity of charge of the power storage device. Then, the indicator light 156 will emit the light or another light with a second color, such as red, that corresponds to a lesser second quantity of charge of the power storage device. In addition, the indicator light 156 does not need to be constantly emitting light. In one embodiment, an activation device on each side of the handle can be pressed simultaneously, and one or both control units send a signal and power to the indicator light 156 to emit a light that corresponds to the amount of charge in the power storage devices.

In another embodiment, the indicator light 156 is provided by a light pipe. In some embodiments, the light pipe is positioned proximate to an aperture within the handle 22. For example, the aperture may be a lanyard aperture and the light pipe may form a ring about an inner surface of the lanyard aperture. The light pipe may be configured to illuminate with at least one color. The at least one color may correspond to an operational status of the charge component. For example, the at least one color may include a first color, a second color, and a third color. For instance, the first color may correspond to a first operational status where a stored power level within the power storage device is below a first power level threshold corresponding to a first quantity of charge. In addition, the second color may correspond to a second operational status where the stored power level within the power storage device is above a second power level threshold corresponding to a second quantity of charge. Further, the third color may correspond to a third operational status where the power storage device is receiving power. The third color may correspond to a third stored power level between the first power level threshold and the second power level threshold, where the third stored power level corresponds to a third quantity of charge. In one non-limiting example, the first color may be red, the second color may be green, and the third color may be yellow. In another non-limiting example, the at least one color may blink intermittently at pre-determined time intervals. A lens may be positioned over the aperture, and the at least one light may be visible through the aperture.

It is noted the above embodiment is illustrative, and that the indicator light 156 may be otherwise configured without departing from the scope of the present disclosure. For example, the indicator light 156 should not be considered as being limiting to 1, 2, 3, or any number of colors. By way of another example, the indicator light 156 should not be considered as being limited to a particular pattern or arrangement of colors corresponding to one or more operational statuses. In this regard, the above embodiment should not be interpreted as limiting the scope of the present disclosure.

Next, the orientation sensor 157 can detect an orientation of the handle to determine which charge component is downward or below the other charge component and closer to a charge base. The orientation sensor 157 can be one or more accelerometers. When the orientation sensor 157 detects the charge component of the first electrical system 155a is below the charge component of the second electrical system 155b, the orientation sensor 157 can provide a signal to one or both of the control units. Based on the signal, the control unit of the first electrical system can allow the respective charge component to charge the respective power storage device, and/or the control unit of the second electrical system can prevent the respective charge component from charging the respective power storage device. One skilled in the art will appreciate various control units and systems for managing the charging of power storage devices, including those found in U.S. Pat. Nos. 8,022,674; 6,805,090; and 8,305,044, the entire disclosures of which are hereby expressly incorporated by reference in their entireties.

Referring now to FIGS. 6D and 6E, further views of electronic components and a folding knife are provided, respectively. In FIG. 6D, one embodiment of the present disclosure includes a power storage device 134, a control unit 138, and wires 146a, 146b that connect the power storage device 134 and the control unit 138. Moreover, a charge component 142 that receives energy is operably connected to the control unit 138. As described elsewhere herein, the charge component 142 can receive power in a wireless manner, which the control unit 138 can route to the power storage device 134 to charge the power storage device 134.

FIG. 6E shows the electronic components positioned in the scale 26 of a folding knife with a blade 6. The electronic components can be positioned in a cavity of the scale 26 and retained by, for example, a deflectable arm 118. The energy stored in the power storage device 134 can be used to power any number of devices. The energy can power any combination of lights, data storage devices, clocks, or any other devices or components described herein and included in or connected to the knife. In addition, the present disclosure encompasses embodiments and tools other than a folding knife.

The electronic components shown in FIGS. 6D and 6E are not physically connected to an activation device such as a button. Instead, a feature of the device in FIGS. 6D and 6E such as a light can be activated in any number of alternative ways. For example, the device may comprise an accelerometer that activates the light when the device is in a particular orientation or range of orientations. Further still, a Global Positioning System (GPS) receiver or other similar receiver can relay the geographic position of the device to the control unit 138, which can then activate or deactivate the light or other feature when the device is within a geographic area, outside of a geographic area, traveling above or below a threshold speed, etc. In some embodiments, an activation device may be positioned on the handle 22 or underneath a moveable portion of the handle 22, and may be activated by bumping, tapping, or otherwise causing the portion of the handle 22 with the activation device to come into contact with the user or the surrounding environment (e.g., a table surface, a tree, or the like). The device, tool, or knife can include a light sensor that turns on the light when the level of the ambient light is below a certain threshold. In some embodiments, an activation device such as a button or light sensor is wirelessly connected to the control unit 138. Thus, when the button is depressed or the light sensor detects ambient light conditions rising above or falling below a threshold in terms of lumens, the light or other feature is activated or deactivated. This wireless connection also allows the cavity that receives the electronic components such as the power storage device 134, the control unit 138, and the charge component 142 to be hermetically sealed with no wires or structure extending beyond an outer surface of the scale 26 or device.

While embodiments of the present disclosure depict a charge component 142 that can wirelessly receive power via electric induction, it will be appreciated that the electronic components can receive power in other ways. In some embodiments, a self-winding rotor mechanism can provide power to the power storage device 134 and the control unit 138 rather than, or in addition to, the charge component 142. A rotating pendulum turns a pinion that is connected to a generator that produces electricity that is stored in the power storage device 134.

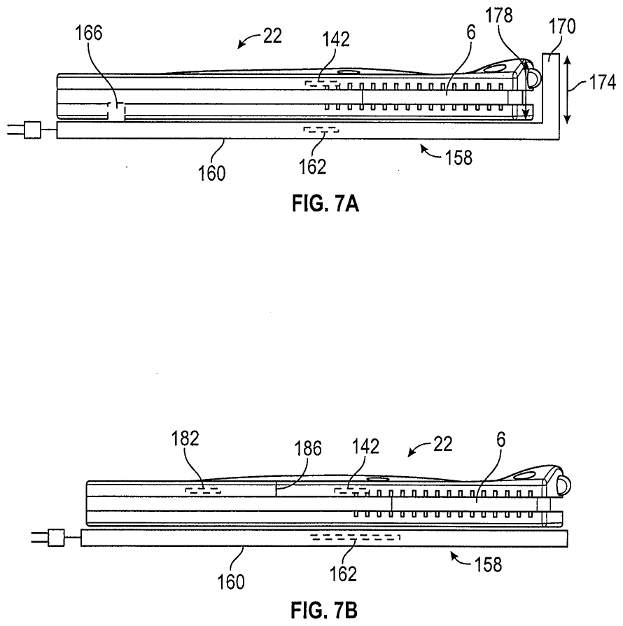

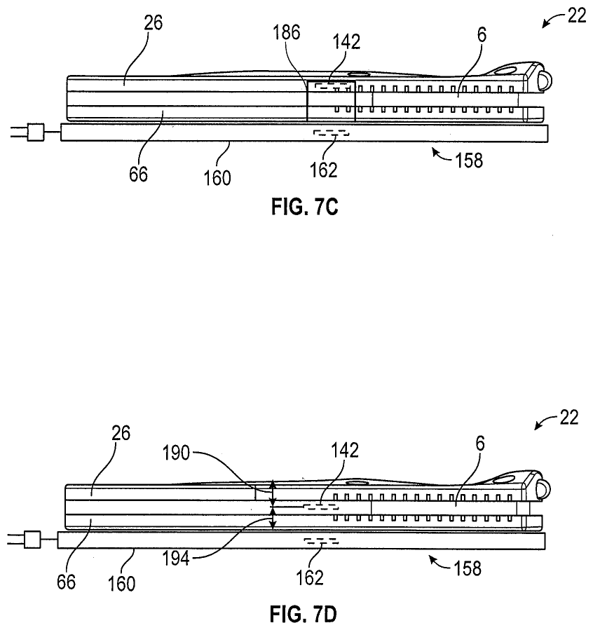

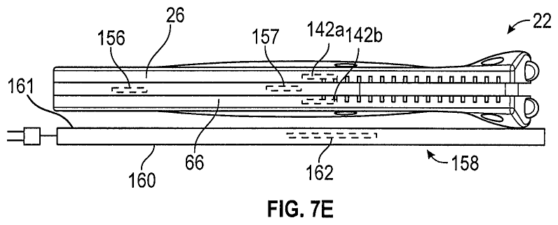

Referring now to FIGS. 7A-7D, bottom elevation views of the folding knife 2 positioned on a charge base 158 are provided, where FIGS. 7A-7D are side elevation views of the charge base 158. For example, the bottom surface 160 of the charge base 158 is positioned on a flat surface, like a table, desk, or countertop. The folding knife 2 and/or charge base 158 can have features that improve the performance of the wireless charging and also improve safety when using the charge base 158. In FIG. 7A, the first charge component 142 of the handle 22 of the folding knife and the second charge component 162 of the charge base 158 are depicted, and a protrusion 166 extending from the charge base 158 is positioned in a recess or aperture in the handle 22 to align the charge components 142, 162. The protrusion 166 can extend into, for instance, the lanyard aperture of the handle 22 to align the charge components 142, 162. It will be appreciated that the various features depicted in FIGS. 7A-7D are exemplary, and embodiments of the present disclosure include, for instance, a charge base 158 that does not have safety features or alignment features.

In FIG. 7B, the second charge component 162 can have a larger length and/or cross-sectional area than the first charge component 142 such that a user does not need to precisely locate the folding knife on the charge base 158 to initiate the charging process. Also shown in FIG. 7B is a position sensor 182 that can detect the position of the blade 6, and more specifically, when the blade 6 is in the closed position within a channel in the handle 22 or when the blade 6 is positioned outside of the handle 22, e.g., in the open and extended position. A shield 186 can be positioned between the first charge component 142 and the position sensor 182 to prevent electromagnetic fields from affecting either of the first charge component 142 or the position sensor 182. The position sensor 182 can serve a variety of functions. For instance, the position sensor 182 can be electrically connected to the control unit, and if the blade 6 is not positioned in the closed position in the handle 22, then the control unit does not transmit power from the first charge component 142 to the power storage devices. The position sensor 182 can be located in a variety of positions in the folding knife 2 and can serve a variety of functions. The position sensor 182 is not limited to the position shown in FIG. 7B. For instance, the position sensor 182 can detect when the blade 6 has moved from the closed position to the open position, and then the position sensor 182 can send a signal to the control unit, which then activates, for instance, a light or a cycle counter that counts the number of opening and closing cycles.

In FIG. 7C, the shield 186 can extend around one or more sides of the first charge component 142 to both insulate the first charge component 142 from external electromagnetic fields and also protect external components from the wireless transmission of power from the second charge component 162 to the first charge component 142. The shield 186 must have at least one open side or open portion to allow the wireless transmission of power from the second charge component 162 to the first charge component 142. In addition, the shield 186 in this embodiment can prevent the wireless transmission of power until the charge components 142, 162 are precisely aligned over or next to each other, which ensures a more efficient transmission of power. Here, the first charge component 142 is positioned in the first scale 26. However, in some embodiments, the first charge component 142 is positioned in the second scale 66 such that it is closer to the charge base 158 and the second charge component 162.

In FIG. 7D, the first charge component 142 is offset 190 from the outer surface of the first scale 26 and offset 194 from the outer surface of the second scale 66. Some wireless protocols for the transmission of power have maximum ranges between charge components 142, 162. Thus, in some embodiments, the offsets 190, 194 are less than 5 cm in some embodiments. It will be appreciated that the offsets 190, 194 can be less than the maximum range of a protocol (e.g., 2 cm, etc.). Moreover, it can be advantageous to have the folding knife charge when one scale is positioned against the charge base 158 but not when the other scale is positioned against the charge base 158. Therefore, in some embodiments, the first offset 190 is greater than 2 cm and the second offset 194 is less than 2 cm, or vice versa, when the maximum range of the wireless protocol is 2 cm.

Referring now to FIG. 7E, a further embodiment of a handle 22 of a tool is provided. Like the handle 22 depicted in FIG. 3B, this handle 22 has lights on either side of the handle 22, i.e., one charge component 142a in the first scale 26 and one charge component 142b in the second scale 66. FIG. 7E shows the handle 22 positioned over a charge base 158 that has a charge component 162. The handle 22 itself has charge components 142a, 142b on opposing sides of the handle 22, an indicator light 156, and an orientation sensor 157. As described above, the indicator light 156 can provide a visual indication of the status of an aspect of the handle 22 or tool such as the amount of charge in one or more power storage devices positioned within the handle 22. A similar description is not repeated here and is instead incorporated by reference.

As also described above, the orientation sensor 157 can help determine the orientation of the handle 22 and specifically which charge component 142a, 142b is positioned beneath the other and, thus, closer to the charge base 158. This is assuming that the bottom surface 160 of the charge base 158 is positioned on a flat, horizontal surface like a table, desk, or countertop. Accordingly, the orientation sensor 157 helps determine which charge component 142a, 142b is closer to the charge component 162 of the charge base 158 for the most efficient and effective charging of the power storage devices in the handle 22. A control unit in the handle can then allow the handle charge component 142a, 142b positioned closer to the charge base charge component 162 to charge the one or more power storage devices, even power storage devices positioned on an opposing side of the handle 22 and/or in a different electrical system. Simultaneously or in the alternative, the control unit can prevent the charge component 142a, 142b positioned above (in the orientation shown) the other charge component, i.e., farther away from the charge base 158, from charging power storage devices. In some embodiments (not shown), the upper surface 161 of the charge base 158 is not flat and, rather, the upper surface 161 has a profile that matches the curvature of the handle such that the handle 22 aligns and sits in the charge base 158. This further positions the handle 22 in the desired charging position.

It will be appreciated that the present disclosure encompasses embodiments not specifically depicted in the various figures. For instance, in some embodiments, the handle 22 does not include an orientation sensor 157, and both charge components 142a, 142b are allowed to receive power from the charge component 162 of the charge base 158, to the extent possible. Similarly, in some embodiments, a material is positioned between charge components 142a, 142b to eliminate interference between charge components 142a, 142b while one charge components 142a, 142b is receiving power from the charge component 162 of the charge base 158. The material can form a partial Faraday cage between the charge components 142a, 142b. The charge components 142a, 142a and charge component 162 of the charge base 158 can conform to the Qi standard or any other standard or protocol for the wireless transfer of power.

The embodiments of FIGS. 7A-7E can also include a magnet in the handle 22 and a magnet in the charge base 158 to properly align the handle 22 with the charge base 158 for efficient charging.

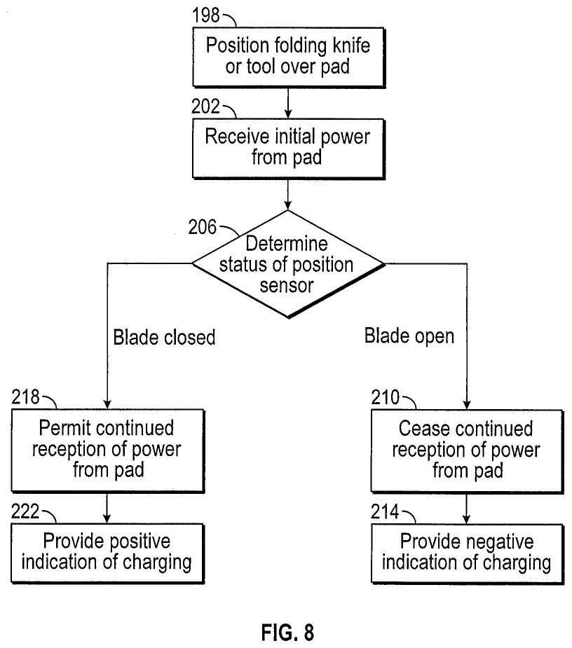

Referring now to FIG. 8, a flowchart for operation of the charging system is provided. First, the folding knife or tool is positioned 198 over or on the charge base, also called a charge pad or pad. Then, the folding knife can initially 202 receive some power to determine 206, for example by the position sensor, if the blade is safely in the closed position in the handle. In some embodiments, the folding knife can rely on the power storage device to power the position sensor and control unit. If the blade is open, then the folding knife, specifically a control unit, can cease 210 charging the power storage device in the folding knife. In various embodiments, an electronic component of the folding knife sends a signal to the charge base such that the charge base prevents the transmission of power to the folding knife. Then, the folding knife can provide 214 a negative indication of charging. In some embodiments, one of the lights emits a red or orange light, indicating caution because the blade is in the open position. If the position sensor determines 206 that the blade is in the closed position in the handle, then the charge pad can continue 218 charging the power storage device in the folding knife. Moreover, the folding knife can provide 222 a positive indication of charging. In various embodiments, one of the lights emits a green light, indicating that the blade is safely in the closed position. It will be appreciated that the present disclosure encompasses embodiments where charging occurs when the blade is in any position or in a particular position.

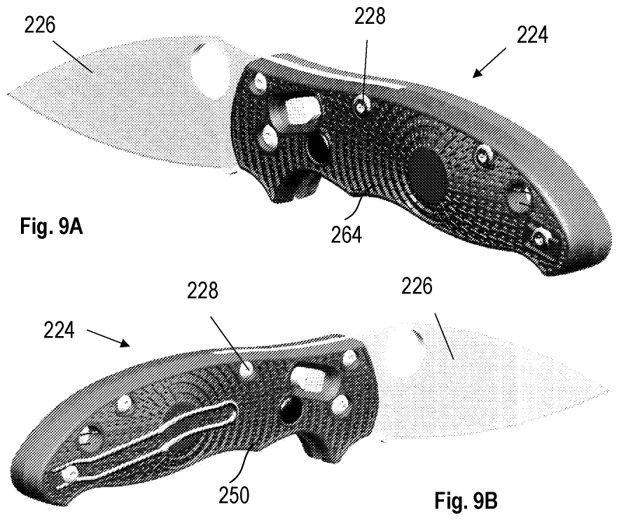

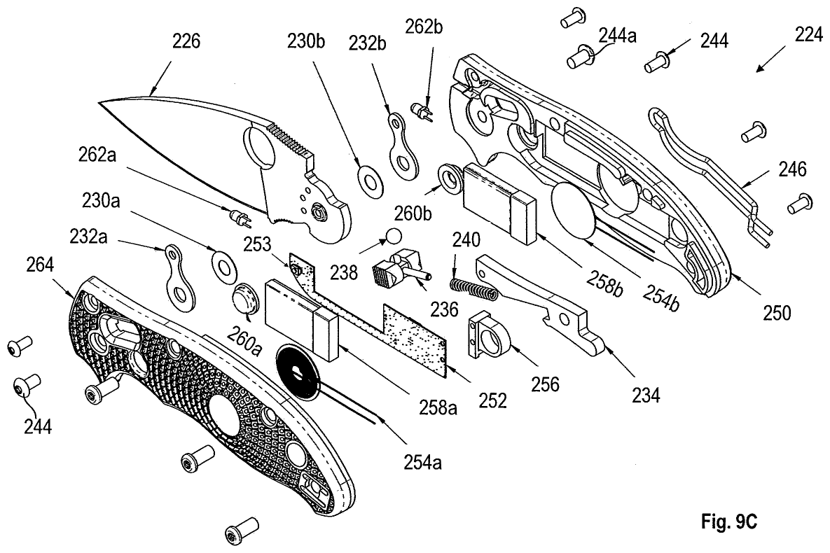

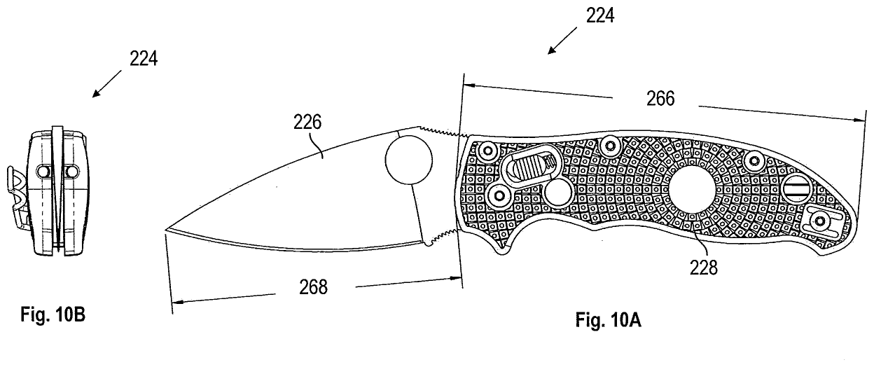

Referring now to FIGS. 9A and 9B, perspective views of a folding knife 224 with a blade 226 and a handle 228 are provided. FIG. 9C shows an exploded view of the components of the folding knife 224 shown in FIGS. 9A and 9B. The folding knife 224 has a blade 226 with a proximal end rotatably connected to scales 250, 264 of a handle. The blade 226 can be connected to the handle 228 by a shaft, pin, or screw 244a and a washer 230a, 230b around the shaft, pin, or screw 244a on either side of the blade 226. In some embodiments, two screws 244a are used to secure the blade 226 to the handle 228. The knife 224 also has two spacers 232a, 232b around the screw 244a on either side of the blade 226 to space the blade 226 apart from the scales 250, 264. For example, the spacers 232a, 232b may be configured to hold in position one or more lights 262a, 262b and/or one or more components of a system that powers the lights 262a, 262b. By way of another example, the spacers 232a, 232b may be configured to engage one or more components of a locking mechanism inserted within the knife 224. Also disposed between the scales 250, 264 of the handle is a back spacer 234. An assembly of a ball holder 236, a ball bearing 238, and a spring 240 are operably connected to the back spacer 234 and the blade 226 to cause the blade 226 to open. The spring 240 can be any bias member with a linear or non-linear response. Also shown in FIG. 9C is a light pipe 256 positioned between the two scales 250, 264 to allow light to emit into a lanyard aperture as described elsewhere herein.

The assembly of the ball holder 236, the ball bearing 238, and the spring 240 may be desirable to some users, as it provides a tactile feedback or a “feel” to assure the user that the blade 226 has opened or closed. Other types of locking mechanisms may be used with less tactile feedback including, but not limited to, a locking and closure detent, an electrical lock, a magnetic lock, a compression lock, a liner lock, a wedge lock, or other locking mechanism known in the art.

Next, FIG. 9C shows the system that powers the lights 262a, 262b that are positioned in respective scales 250, 264. An electrode and a power coil 254a, 254b are positioned in respective scales 250, 264 where the coils 254a, 254b can power respective batteries 258a, 258b as described herein. Between batteries 258a, 258b is a substrate 252 that can communicate a signal from a user pressing a button 260a, 260b on either side of the folding knife 224. Via the substrate 252, a signal can be relayed and, with a control device 253, cause the lights 262a, 262b to emit electromagnetic radiation as described herein. Finally, the folding knife 224 can be assembled with screws 244, and a clip 246 can be attached to one of the scales 250, 264.

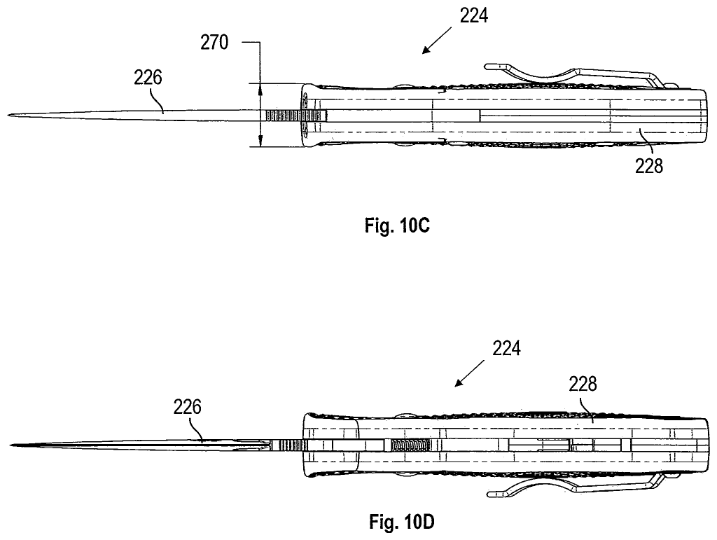

Now referring to FIGS. 10A-10D, various views of the folding knife 224 shown in FIGS. 9A-9C are provided. FIG. 10A is a front elevation view, FIG. 10B is a side elevation view, FIG. 10C is a top plan view, and FIG. 10D is a bottom plan view of the folding knife 224.

FIGS. 10A and 10C show various dimensions of the folding knife 224. In some embodiments, the length 268 of the blade 226 is between about 2.0 inches and about 5.0 inches. In a preferred embodiment, the length 268 is between about 2.5 inches and about 4.0 inches. In some embodiments, the length 266 of the handle 228 is between about 2.5 inches and about 7.0 inches. In a preferred embodiment, the length 266 is between about 3.0 inches and about 5.0 inches. In some embodiments, the width 270 of the forward end of the handle 228 is between about 0.5 inches and about 1.0 inch.

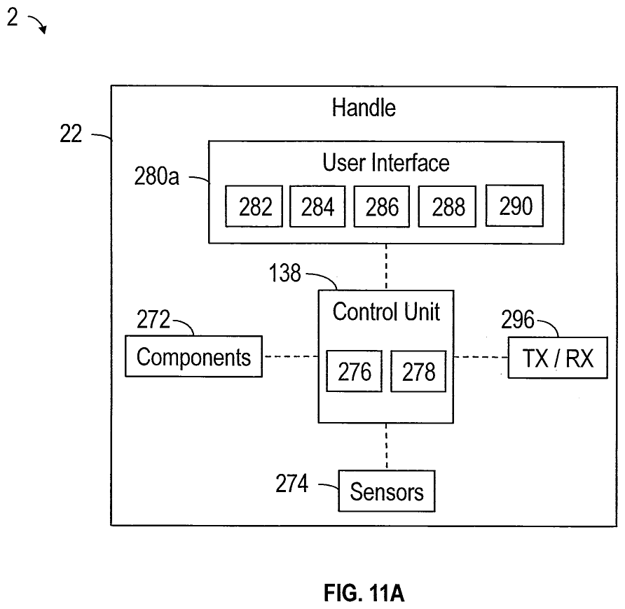

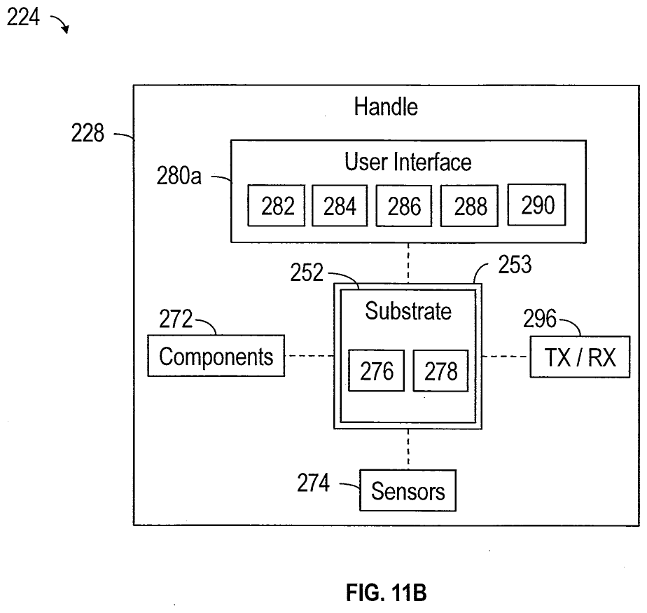

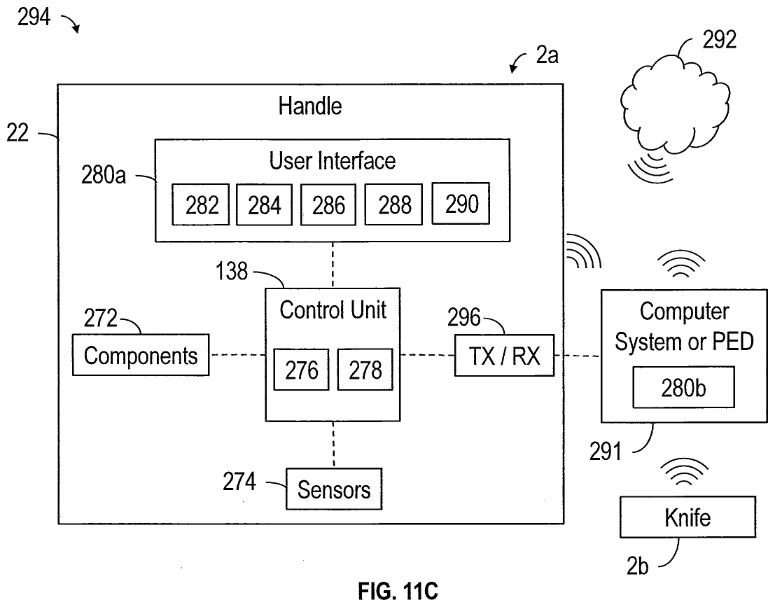

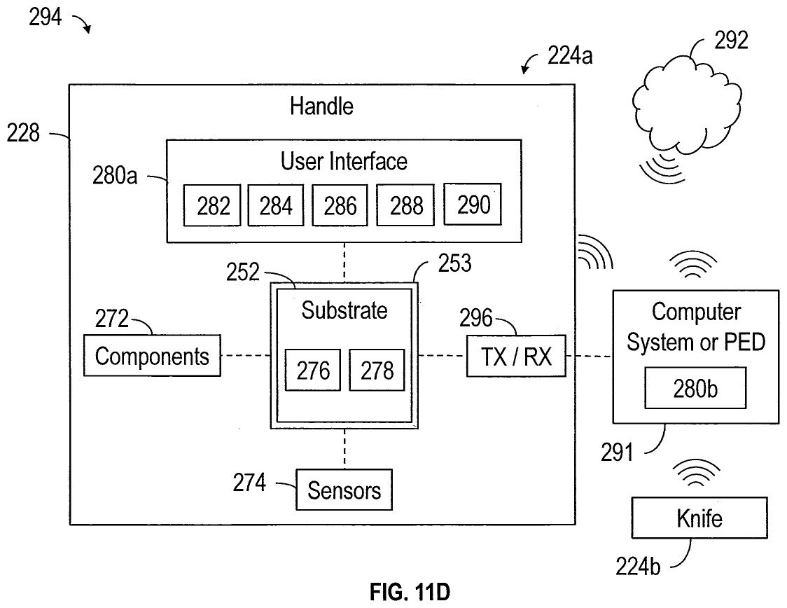

Referring now to FIGS. 11A-11D, the handheld tools as described throughout the present disclosure (e.g., including, but not limited to, the folding knife 2 and/or the folding knife 224) are configured with electronic features or components. In addition, the handheld tools as described throughout the present disclosure (e.g., including, but not limited to, the folding knife 2 and/or the folding knife 224) include additional internal components configured to perform or provide data for the electronic features or components.

In some embodiments, the knife 2, 224 includes components 272 installed within the handle 22, 228. The components 272 may be operably connected or coupled to the control unit 138, 138a, 138b and/or the control device 253 coupled to the substrate 252, or may be standalone. The components 272 may provide increased functionality for the knife 2, 224. It is noted that component numeral 138 includes the control units 138a and 138b, and the descriptions herein apply to control units 138, 138a, 138b.

For example, the components 272 may include any component necessary to collect data as described throughout the present disclosure. For instance, the components 272 may include, but are not limited to, an emergency locator or beacon, a compass, an altimeter, a barometer, a thermometer, a pH sensor, or the like. Further, the components 272 may include, but are not limited to, a fitness tracker, a position sensor (e.g., 2-axis, 3-axis, 5-axis, 6-axis, or any number of axes), an accelerometer or G meter, a heart monitor, a blood sugar monitor, a pulse oximeter, or the like. Further, the components 272 may include, but are not limited to, a location tag (e.g., AirTag, Tile, or the like) to determine whether the knife or tool is in close proximity to the user or the user's smart phone or other electronic device, when locating the knife or tool. Further, the components 272 may include, but are not limited to, a proximity sensor to determine whether the user or the user's smart phone or other electronic device is in close proximity to the knife or tool. Where a proximity sensor is installed, the proximity sensor may operate via Bluetooth, NFC, or other wireless connection to alert a user to the location of the knife based on its proximity to the user's smart phone or electronic device in possession of the user or, alternatively, the location of the user's smart phone or electronic device based on its proximity to the knife in possession of the user. The control unit 138, 138a, 138b and/or the control device 253 may receive data from the proximity sensor to generate one or more aural, visual, and/or haptic outputs from the knife 2, 224, The outputs may direct the user to the location of the smart phone or electronic device. In one non-limiting example, the outputs may indicate degree of proximity by increasing or decreasing an intensity, type, or pattern of an outputted color, pattern, sound or pitch, vibration, etc. as a user moves closer to or farther away from the smart phone or electronic device. In another non-limiting example, the outputs may be consistently supplied to the user during the locating of the smart phone or electronic device. Alternatively, the smart phone or electronic device can indicate the degree of proximity to the knife.

By way of another example, the components 272 may include a watch or internal clock (e.g., including a travel alarm, stopwatch, or timer), a laser pointer or targeting tool, a laser sight or distance measurement device, one or more assignable sensors, a mechanical sound emitter configured to activate when struck (e.g., a bell, chime, block, or the like), provided with air flow (e.g., a whistle, or the like), drawn on or against (e.g., a thin metal band or string, or the like), a hand warmer, etc.

In various embodiments, one or more sensors 274 are housed within, mounted on, and/or otherwise integrated into the knife 2, 224 or tool. The one or more sensors 274 may be operably connected or coupled to the control unit 138, 138a, 138b and/or the control device 253 coupled to the substrate 252. At least some of the sensors 274 can be integrated in one or more components 272 installed within the knife 2, 224.

The one or more sensors 274 may be configured to monitor the knife 2, 224 and capture or collect operation data related to the operation or handling of the knife 2, 224. For example, the data may be related to a locking mechanism or an opening mechanism being activated or deactivated. For instance, recognizing the locking mechanism or the opening mechanism being activated or deactivated may provide an indication whether the knife 2, 224 is open or closed. By way of another example, the data may be related to a blade cycle count, an amount of remaining charge (charge level) of the internal battery 258a, 258b, time in use since charge, total time since charge, battery condition or health, or the like.

In some embodiments, the internal battery 258a, 258b may power the internal components of the knife 2, 224. In addition, the internal battery 258a, 258a may be charged via a wired or wireline connection (e.g., the USB 128, a magnetic connector or plug, a non-magnetic connector or plug, or the like) or a wireless connection (e.g., induction charging, or the like). Further, the internal battery 258a, 258b may charge another device (e.g., a second knife 2b, 224b, a personal electronic device (PED), or the like) via the wired connection or the wireless connection. The wired connection may be self-connecting or self-retaining (e.g., is magnetic, includes physical guides or pins, includes interlocking assemblies, or the like).

By way of another example, the data may be related to the lights 42a, 42b, 42c being activated or deactivated. For instance, the lights may be fully activated or activated at a set or selected output level, which may be controllable via user input devices, as described throughout the present disclosure For example, the lights 42a, 42b, 42c may be activated at half power or half luminosity or brightness or some other fraction between zero and full brightness.

By way of another example, the data may be related to aural, visual, and/or haptic inputs or outputs with the knife 2, 224. For instance, the one or more sensors 274 may be configured to capture or collect data related to inputted or outputted sounds, inputted or outputted lights, images, or videos, inputted or outputted vibrations or touch commands, or other aural, visual, and/or haptic inputs or outputs as described throughout the present disclosure.

By way of another example, the data may be related to an internal clock onboard the knife 2, 224. By way of another example, the data may be related to information received or transmitted via a wired or wireless communication device, or an onboard data storage device with an interface such as the USB 128 or memory card receptable.

The one or more sensors 274 may be configured to monitor and capture or collect environment data related to an environment surrounding or a location of the knife 2, 224. For example, the data may be related to a GPS signal, a compass heading, an altimeter reading, a barometer reading, a thermometer reading, a hygrometer (humidity) reading, a pH reading, or other environmental data.

The one or more sensors 274 may be configured to monitor and capture or collect user data related to a user or holder of the knife 2, 224. For example, the data may be related to a fitness measurement, a position measurement of the knife relative to the user or a portion of the user (e.g., foot, leg, hand, arm, shoulder, head, or the like), an accelerometer or G meter reading, a heart rate or pulse rate, a blood sugar level, a pulse oximetry reading, or other sensors or internal components as described throughout the present disclosure.

In some embodiments, the control unit 138, 138a, 138b and/or the control device 253 coupled to the substrate 252 includes one or more processors 276 and memory 278. The memory 278 is configured to store a set of program instructions. The one or more processors 276 are configured to execute program instructions causing the one or more processors 276 to perform one or more steps of methods or processes related to a program or application (app) as described throughout the disclosure.

The one or more processors 276 may include any processor or processing element known in the art. For the purposes of the present disclosure, the term “processor” or “processing element” may be broadly defined to encompass, but is not limited to, any device having one or more processing or logic elements, e.g., one or more graphics processing units (GPU), micro-processing units (MPU), systems-on-a-chip (SoC), one or more application specific integrated circuit (ASIC) devices, one or more field programmable gate arrays (FPGAs), or one or more digital signal processors (DSPs). In this sense, the one or more processors 276 may include any device configured to execute algorithms and/or instructions, e.g., program instructions stored in memory 278. In one example embodiment, the one or more processors 276 may be embodied as a computer system configured to execute a program configured to operate in conjunction with components installed within the same knife 2, 224, and/or configured to operate in conjunction with multiple localized or global knives 2, 224 either directly or via a third-party server.

The memory 278 may include any storage medium known in the art suitable for storing program instructions executable by the associated one or more processors 276. For example, the memory 278 may include a non-transitory memory medium. By way of another example, the memory 278 may include, but is not limited to, a read-only memory (ROM), a random-access memory (RAM), a magnetic or optical memory device (e.g., disk), a magnetic tape, a solid-state drive, or the like. It is further noted that the memory 278 may be housed in a common controller housing with the one or more processors 276. In one example embodiment, the memory 278 may be located remotely with respect to the physical location of the respective one or more processors 276. For instance, the respective one or more processors 276 may access a remote memory 278 (e.g., server), accessible through a network (e.g., internet, intranet, or the like).

In some embodiments, the control unit 138, 138a, 138b and/or the control device 253 coupled to the substrate 252 include or are coupled to (e.g., physically coupled, electrically coupled, communicatively coupled, or the like) one or more user interfaces 280. For example, the one or more user interfaces 280 may provide user inputs to the control unit 138, 138a, 138b and/or the control device 253 coupled to the substrate 252. For instance, the user inputs may direct the control unit 138, 138a, 138b and/or the control device 253 coupled to the substrate 252 to control select components of the knife 2, 224. By way of another example, the one or more user interfaces 280 may provide information to a user.

The one or more user interfaces 280 may include a display 282 used to display data of the knife 2, 224. The display 282 of the one or more user interfaces 280 may include any display known in the art. For example, the display 282 may include, but is not limited to, a liquid crystal display (LCD) or an organic light-emitting diode (OLED) based display, or other known display. By way of another example, the display may be backlit or non-backlit. Those skilled in the art should recognize that any display or display device capable of integration with a user interface is suitable for implementation in the present disclosure.

The one or more user interfaces 280 may include one or more user input devices 284. A user may input selections and/or instructions via the one or more user input devices 284, which may be unprompted or may be responsive to data displayed to the user via the one or more displays 282. For example, the one or more user input devices 284 may include, but are not limited to, one or more button, toggles, switches, electrical contacts, or the like. For instance, the one or more user input devices 284 may include, but are not limited to, activation devices 46 or the like, as described throughout the present disclosure. In addition, the one or more user input devices 284 may include, but are not limited to, a touch pad, a touch screen, or the like, which are integrated with the display 282. Further, the one or more user input devices 284 may include, but are not limited to, a microphone used to receive verbal communication from the user (e.g., voice commands or prompts and/or input from a user such as verbal user notes or user conversations), or an optical sensor configured to receive electromagnetic radiation (e.g., infrared radiation (IR), visible light, ultraviolet (UV) radiation, or the like). It is noted the user interface 280 may be configured to receive input via the display 282 and/or the user input device 284 to record typed or transcribed user notes. In general, the one or more user interfaces 280 may include any type of human-machine interface. It is noted that component numeral 280 includes the user interfaces 280a and 280b, and the descriptions herein apply to user interfaces 280, 280a, 280b.

The one or more user interfaces 280 may include one or more aural output devices 286. For example, the one or more aural output devices 286 may include, but are not limited to, headphone jacks, audio speakers, mechanical sound generators, or the like. For instance, the one or more aural output devices 286 may provide commands or prompts (e.g., timers, connected computer system or personal electronic device (PED) alarms, GPS directions, or the like) or other audio (e.g., call sounds, music, or the like) to a user. In this regard, the knife 2, 224 may be operable as a music player via the TX/RX unit (e.g., via Bluetooth, or the like) and/or via a component such as a headphone jack or an audio speaker.

The one or more user interfaces 280 may include one or more haptic output devices 288. For example, the one or more haptic output devices 288 may include, but are not limited to, buzzers, a vibration motor, or the like.

The one or more user interfaces 280 may include one or more visual input devices 290. For example, the one or more visual input devices 290 may include, but are not limited to, one or more cameras configured to capture and/or record images or videos. For instance, the control unit 138, 138a, 138b and/or the control device 253 coupled to the substrate 252 may be capable of compiling data from the one or more cameras and outputting it to a computer system or personal electronic device (PED) 291 (e.g., including the user interface 280b) or a third-party server (e.g., at manually selected times, at pre-determined times, at on-demand times or during streaming sessions, or the like). The memory 278 and/or a third-party server may be configured to store the images or videos. In addition, the computer system or personal electronic device 291 (e.g., including the user interface 280b) and the third-party server may be configured with processors, memory, user interfaces, user input devices, or other components related to the control unit 138, 138a, 138b and/or the control device 253 as described throughout the present disclosure.

As illustrated in FIGS. 11A and 11B, the one or more user interfaces 280a may be components of the knife 2, 224. For example, the one or more user interfaces 280a may be housed within the handle 22, 228. For instance, components or portions of the one or more user interfaces 280 may be accessible or visible within the handle 22, 228.

As illustrated in FIGS. 11C and 11D, the second user interface 280b may be a part of a computer system or personal electronic device 291. For example, the computer system may include a desktop computer, mainframe computer system, workstation, image computer, parallel processor, networked computer, or any other computer system. By way of another example, a personal electronic device may include a tablet, smartphone, laptop, global positioning system (GPS) device, or other personal electronic device. The computer system or personal electronic device 291 may be configured to interface with the control unit 138, 138a, 138b and/or the control device 253 coupled to the substrate 252 of the knife 2, 224 (respectively) via wired or wireless communication. The computer system or personal electronic device 291 may be held by the user or a third party. In addition, the knife 2, 224 and the computer system or personal electronic device 291 may be in direct communication, or in communication via at least one intermediate server 292. Some or all of the one or more knives 2a, 2b, 224a, 224b, the computer system or personal electronic device 291, and the intermediate server 292 may be considered components of a system 294, for purposes of the present disclosure.

The knife 2, 224 may be configured to receive and/or transmit data. The data may be received and/or transmitted as a standardized data format shared by the knife 2, 224, the computer system or personal electronic device 291, and the intermediate server 292. For example, the standardized data format may be formatted for use with different operating systems including, but not limited to, Android, Apple iOS, Microsoft Windows, Apple macOS, Linux, ChromeOS, Unix, Ubuntu, or the like.

It is noted herein, however, the knife 2, 224 may use a first type of file format, while the computer system or personal electronic device 291 and/or the intermediate server 292 may use a different type of file format. As such, the data may be a non-standardized data format requiring conversion. For example, the knife 2, 224 may transmit the data in the non-standardized data format to the computer system or personal electronic device 291 and/or the intermediate server 292, and the computer system or personal electronic device 291 and/or the intermediate server 292 may convert the data into a standardized data format following receipt. By way of another example, the knife 2, 224 may convert the data into a standardized data format prior to transmission to the computer system or personal electronic device 291 and/or the intermediate server 292. In addition, the data may be uploaded to the computer system or personal electronic device 291 and/or the intermediate server 292 as a proprietary data format specific to the system 294. Further, the data may be shared using encrypted data (e.g., via daemons), web or cloud interfaces, or other secure connections using die traceability to ensure the data stays synchronized. Although the above examples are directed to the knife 2, 224 transmitting data to the computer system or personal electronic device 291 and/or the intermediate server 292, it is noted similar pathways of converting data between standardized and non-standardized data formats may occur with respect to the knife 2, 224 receiving data from the computer system or personal electronic device 291 and/or the intermediate server 292.

The wired or wireless communications between components within the same knife 2, 224, between a knife 2, 224 and an external user interface 280b, and/or between multiple localized or global knives 2, 224 may include a wired connection (e.g., physical communication port such as USB, copper wire, fiber optic cable, or the like) or wireless connection (e.g., RF coupling, IR coupling, NFC coupling, Wi-Fi, WiMax, Bluetooth, 3G, 4G, 4G LTE, 5G, or the like).

In example embodiments, the knife 2, 224 includes one or more devices for at least one of data transmission or reception. For instance, the one or more devices may include a transmitter (TX) unit, a receiver (RX) unit, and/or a transmitter and receiver (TX/RX) unit. Although the present disclosure describes the transmission and reception of data via the TX/RX units 296, embodiments related to the transmission of data via the TX/RX units 296 should be understood as being capable by a standalone TX unit, and vice versa, without departing from the scope of the present disclosure. In addition, embodiments related to reception of data via the TX/RX units 296 should be understood as being capable by a standalone RX unit, and vice versa, without departing from the scope of the present disclosure. In this regard, embodiments and illustrations directed to the TX/RX units 296 may be understood as also being directed to standalone TX units and/or standalone RX units, for purposes of the present disclosure.

The transmitter and receiver (TX/RX) units 296 or transceiver units 296 may be operably connected or coupled to the control unit 138, 138a, 138b and/or the control device 253 coupled to the substrate 252. The TX/RX units 296 may be configured to operate on wireless connections as described above. In one non-limiting example, the TX/RX units 296 may be configured to operate on Bluetooth and may be configured to transmit and/or receive information related to the Bluetooth connection. For instance, the information may include, but is not limited to, Bluetooth registration number and/or registration capacity of the knife 2, 224. In addition, the information may include, but is not limited to, proximity recognition of additional knives 2b, 224b (e.g., as illustrated in FIGS. 11C and 11D).

The configuration of the electrical system 115 and the blade 6 within the handle 22 may provide a radiation path with a reduced level of obstruction for at least one of receiving and transmitting data via the wired or wireless connection (e.g., the TX/RX units 296 configured to operate on Bluetooth, or the like).

The knife 2, 224 may be configured to receive and/or transmit data related to an emergency locator or beacon. The emergency locator or beacon may be configured to operate with cell phone, satellite, or GPS communication protocols. The emergency locator or beacon may be built into the control unit 138, 138a, 138b and/or the control device 253 coupled to the substrate 252. The emergency locator or beacon may be a component 272 built into the handle 22, 228 and coupled to the control unit 138, 138a, 138b and/or the control device 253 coupled to the substrate 252. The emergency locator or beacon may transmit an SOS via cell phone, satellite, or GPS communication protocols when activated, which may be received by rescue organizations and responders. The emergency locator or beacon may generate a signal that allows for the tracking of the knife 2, 224 and a user in possession of the knife 2, 224 in real-time via an online or application mapping service including, but not limited to, Google Maps, Apple Maps, or the like. The emergency locator or beacon may work with communication channels within the knife 2, 224 and/or communication channels shared with a computer system or personal electronic device (e.g., via Bluetooth, NFC, or the like). For example, the emergency locator or beacon may transmit messages including manually typed or pre-determined location information to selected contacts or emergency responders. By way of another example, the emergency locator or beacon may allow for continued, real-time communication with contacts or emergency responders.

The knife 2, 224 may be configured to receive and/or transmit data related to operational information, which can include operational statistics. For example, the operational information may include, but is not limited to, power storage device level, power storage device charge rate and/or discharge rate, cycle count of components installed within the knife 2, 224 (e.g., such as a count of number of times the blade 2, 226 has opened or closed), or the like. In general, the operational information for the knife 2, 224 may include any data generated by sensors or components within the knife 2, 224. In addition, the operational information for the knife 2, 224 may include data received by sensors within the knife 2, 224 and/or the TX/RX unit 296 of the knife 2, 224 related to the operation of the knife, surrounding environment information including GPS, or the like.

The knife 2, 224 may be configured to transmit signals to or receive signals from third-party electronic devices. For example, the TX/RX unit 296 may be configured to transmit radio waves at wavelengths used for garage door openers (e.g., ranging between 290 and 400 Megahertz (MHz)) to open and/or close, turn on and/or off lights, lock and/or unlock, or the like for the garage door. By way of another example, the TX/RX unit 296 may be configured to transmit a signal to a vehicle (e.g., similar to a key fob or phone application) including, but not limited to, remote start or autostart, door locking and/or unlocking, window opening and/or closing, door opening and/or closing, tailgate or hatch opening and/or closing, or the like. By way of another example, the TX/RX unit 296 may be configured to receive information related to the car's performance or operational data (e.g., similar to a key fob or phone application, which stores the operational data for later recall or review). The knife 2, 224 may include a plug or receptacle that is configured to mate (e.g., either directly, or through a connector wire or adaptor) to a vehicle's onboard diagnostics port (e.g., OBD II port, or the like).

The knife 2, 224 may be configured to receive one or more signals with operation commands from a personal electronic device via said TX/RX unit 296. In this regard, a user may control one or more components (or operations of the components) installed within the knife 2, 224. For example, the knife 2, 224 may be configured to receive signals to activate or deactivate components (e.g., visual or aural output devices), start and/or stop data collection (e.g., with sensors), start and/or stop data receiving or transmission (e.g., via the TX/RX unit 296 including, but not limited to, Bluetooth), or the like.

The knife 2, 224 may be configured to receive and/or transmit data related to knife ownership, knife registration or support, or other related data. It is contemplated the data may be transmitted to or received from another knife 2b, 224b and/or a program or application (app) run on a computer system or personal electronic device 291 (e.g., including the second user interface 280b). The program or app may be configured to provide a user portal or dashboard for app-based services. In one non-limiting example, the user portal or dashboard may display internal operation data for the knife 2, 224. In another non-limiting example, the user portal or dashboard may display user data (e.g., health data). In another non-limiting example, the user portal or dashboard may display surrounding environment data at the present time (e.g., real-time capture of environment data and/or GPS, or the like) previous times (e.g., historical GPS data, or the like), and/or future occurrences (e.g., weather forecasts, or the like). In another non-limiting example, the user portal or dashboard may display or provide the current ownership, chain of ownership, or registration information to a server. In another non-limiting example, the user portal or dashboard may allow for the submission of a request and provide a communication channel with a third party (e.g., a phone call with a contact, a support representative for assistance with the knife 2, 224, or the like). In another non-limiting example, the user portal or dashboard may display the location of the knife 2, 224 if lost or otherwise misplaced. It is noted the knife 2, 224 may be configured to be usable to locate the computer system or personal electronic device 291 if lost or otherwise misplaced.

The program or app may provide the knife 2, 224 with information related to the operation of the connected second knife 2b, 224b and/or the computer system or personal electronic device 291 (e.g., including the second user interface 280b) or third-party server running the program or app. For example, the knife 2, 224 may be configured to ring or vibrate when a phone call is received, ring or vibrate when an alarm plays, emit sound when sound is output, or provide other aural, visual, or haptic feedback in synchronicity with (or instead of) the computer system or personal electronic device. By way of another example, the knife 2, 224 may be usable as an electronic tool to lock or unlock the computer system or personal electronic device (e.g., a proximity lock), instead of or in addition to (e.g., two-factor authentication) a pin, swipe pattern, fingerprint, facial recognition, or the like.

The program or app may provide a user or third party with information related to promotional and advertising services, based on the usage of the knife 2, 224. For example, the knife 2, 224 may collect information about the usage of the knife 2, 224 (e.g., geographic location of the knife 2, 224, information from images or videos captured with the knife 2, 224, and other usage information) and transmit the information to a third party. The third party may manually select or have automatically generated promotional or advertising material based on the information (e.g., material for retailers and services within the similar geographic area, material related to items observed in the captured images or photos, or other promotional or advertising material). The user may receive the promotional or advertising material via the knife 2, 224 or via the program or app on a computer system or personal electronic device 291 (e.g., including the second user interface 280b) connected with the knife 2, 224.

Although the figures depict a folding knife, it will be appreciated that embodiments of the present disclosure encompass a variety of handheld tools and tool handles. For instance, embodiments of the present disclosure encompass a fixed blade knife with a handle that can incorporate various aspects of the present disclosure including the sealed, planar power storage device and charge component, the arrangement of channels and reinforcement area, and the charge base. In this regard, embodiments related to a knife may be directed to a tool without departing from the scope of the present disclosure. Thus, embodiments of the present disclosure encompass, but are not limited to, folding blade knives, fixed blade knives, multi-tools, box cutters, scissors, saws, drills, hammers, screwdrivers, ratchets, pliers, wrenches, snips, levels, tape measurers, shovels, gardening and tree trimming tools, battery-operated power tools, and any other handheld tool with a handle that can incur the benefits of aspects described herein.

The foregoing description of the present disclosure has been presented for illustration and description purposes. However, the description is not intended to limit the disclosure to only the forms disclosed herein. In the foregoing Detailed Description for example, various features of the disclosure are grouped together in one or more embodiments for the purpose of streamlining the disclosure. This method of disclosure is not to be interpreted as reflecting a disclosure that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Consequently, variations and modifications commensurate with the above teachings and skill and knowledge of the relevant art are within the scope of the present disclosure. The embodiments described herein above are further intended to explain best modes of practicing the disclosure and to enable others skilled in the art to utilize the disclosure in such a manner, or include other embodiments with various modifications as required by the particular application(s) or use(s) of the present disclosure. Thus, it is intended that the claims be construed to include alternative embodiments to the extent permitted by the prior art.

Additionally, various features/components of one embodiment may be combined with features/components of another embodiment. For example, features/components of one figure can be combined with features/components of another figure or features/components of multiple figures. To avoid repetition, every different combination of features has not been described herein, but the different combinations are within the scope of this disclosure. Additionally, if details (including angles, dimensions, etc.) about a feature or component are described with one embodiment or one figure, then those details can apply to similar features of components in other embodiments or other figures.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A handheld tool that wirelessly receives power, comprising:
a handle defining a first cavity and a second cavity;
an electrical system at least partially positioned in said first cavity, wherein said electrical system comprises a charge component for receiving power and transferring power to a power storage device, and an activation device operably connected to said power storage device;
a control unit of said electrical system, said control unit at least partially positioned in said first cavity; and
one or more sensors, each of said one or more sensors at least partially positioned within said first cavity or said second cavity, each of said one or more sensors configured to collect sensor data and provide said sensor data to said control unit.

2. The handheld tool of claim 1, wherein said one or more sensors are configured to collect operation data about one or more components of said handheld tool and provide said operation data to said control unit, wherein said operation data includes at least one of amount of remaining charge of said power storage device, time in use since charge of said power storage device, total time since charge of said power storage device, condition or health of said power storage device, light activation or deactivation, tool lock activation or deactivation, tool cycle count, aural inputs or outputs, visual inputs or outputs, or haptic inputs or outputs.

3. The handheld tool of claim 1, wherein said one or more sensors are configured to collect environment data about a surrounding environment in which the handheld tool is operated and provide said environment data to said control unit, wherein said environment data includes at least one of a GPS signal, a compass heading, an altimeter reading, a barometer reading, a thermometer reading, a hygrometer reading, or a pH reading.

4. The handheld tool of claim 1, wherein said one or more sensors are configured to collect user data about a user operating the handheld tool and provide said user data to said control unit, wherein said user data includes at least one of a fitness measurement, a position measurement of said handheld tool relative to a portion of said user, an accelerometer or G meter reading, a heart rate or pulse rate, a blood sugar level, or a pulse oximetry reading.

5. The handheld tool of claim 1, further comprising a data storage device at least partly positioned in said handle.

6. The handheld tool of claim 5, further comprising:
a microphone positioned within said handle and configured to receive verbal communication from a user, said control unit being configured to store said verbal communication in said data storage device.

7. The handheld tool of claim 5, further comprising:
a camera positioned within said handle and configured to capture at least one of an image or a video, said control unit being configured to store said at least one of an image or a video in said data storage device.

8. The handheld tool of claim 5, wherein said data storage device is at least one of memory integrated in said control unit or a flash medium including a USB drive or a memory card insertable in said handle.

9. The handheld tool of claim 1, wherein said electrical system comprises a light operably connected to said power storage device.

10. The handheld tool of claim 1, further comprising:
a user interface in communication with said control unit, said user interface at least partially positioned within said handle, and said user interface comprising a display.

11. The handheld tool of claim 10, wherein said user interface is in communication with a second activation device, wherein said second activation device activates a light within said handle.

12. The handheld tool of claim 1, further comprising:
one or more components at least partially positioned within said first cavity or said second cavity, said one or more components including at least one of an emergency locator or beacon, a compass, an altimeter, a barometer, a thermometer, a pH sensor, a fitness tracker, a position sensor, an accelerometer or G meter, a heart monitor, a blood sugar monitor, a pulse oximeter, a location tag, a watch or internal clock, a laser pointer or targeting tool, a laser sight or distance measurement device, a mechanical sound emitter, or a hand warmer, and wherein at least some of said one or more components are operably connected to said control unit.

13. The handheld tool of claim 1, comprising a folding blade knife, a fixed blade knife, a multi-tool, a box cutter, scissors, a saw, a drill, a hammer, a screwdriver, a ratchet, pliers, a wrench, snips, a level, a tape measurer, a shovel, a gardening or tree trimming tool, or a battery-operated power tool.

14. A handheld tool that wirelessly receives power, comprising:
a handle defining a first cavity;
an electrical system at least partially positioned in said first cavity, wherein said electrical system comprises a charge component for receiving power and transferring power to a power storage device, a control unit, and an activation device operably connected to said power storage device; and
a light pipe configured to illuminate with at least one color from at least one indicator light, wherein said at least one color corresponds to an operational status of said charge component.

15. The handheld tool of claim 14, wherein the light pipe is positioned proximate to an aperture in said handle.

16. The handheld tool of claim 15, wherein said aperture is a lanyard aperture, wherein said light pipe forms a ring about an inner surface of said lanyard aperture.

17. The handheld tool of claim 14, wherein said light of at least one color comprises:
a first color corresponding to a first operational status where a stored power level within said power storage device is below a first power level threshold;
a second color corresponding to a second operational status where said stored power level within said power storage device is above a second power level threshold; and
a third color corresponding to a third operational status where said power storage device is receiving power.

18. The handheld tool of claim 14, wherein said at least one color blinks intermittently at pre-determined time intervals.

19. The handheld tool of claim 14, further comprising:
a lens positioned over said aperture, wherein said at least one light is visible through said lens, wherein said lens is fabricated from a plastic, a protective glass, or a glass with one or more focusing, magnifying, reflective, or refractive properties.

20. A knife that wirelessly receives power, comprising:
a handle defining a first cavity;
an electrical system at least partially positioned in said first cavity, wherein said electrical system comprises a charge component for receiving power and transferring power to a power storage device, a control unit, and an activation device operably connected to said power storage device; and
a light electrically connected to the electrical system.
